(19) United States
(12) Patent Application Publication
(10) Pub. No.: US 2018/0158162 A1
(43) Pub. Date: Jun. 7, 2018

(54) SYSTEM AND METHOD FOR MICROSHARE BASED CONTENT FUNDING AND DISTRIBUTION

(71) Applicant: Celambarasan Ramasamy, Pasadena, CA (US)

(72) Inventor: Celambarasan Ramasamy, Pasadena, CA (US)

(21) Appl. No.: 15/889,214

(22) Filed: Feb. 6, 2018

Related U.S. Application Data
(63) Continuation of application No. PCT/US16/46083, filed on Aug. 8, 2016.
(60) Provisional application No. 62/202,848, filed on Aug. 9, 2015.

(51) Int. Cl. G06Q 50/18; G06Q 20/38; G06Q 20/40; H04L 9/14; H04L 9/30; H04L 9/06; H04L 9/32

(52) U.S. Cl. CPC G06Q 50/184; G06Q 20/3829; G06Q 20/3827; G06Q 20/3825; G06Q 20/4014; G06Q 30/0215; H04L 9/30; H04L 9/0637; H04L 9/3247; G06Q 2220/00; H04L 9/14

(57) ABSTRACT

A system and method for enhancing digital media by embedding property rights into media using a digital signature infrastructure, so as to enable the creation of limited edition digital memorabilia in the form of media content.

### CROSS-REFERENCE TO RELATED APPLICATIONS

This application is a continuation of PCT Application No. PCT/US16/46083 titled, “SYSTEM AND METHOD FOR MICROSHARE BASED CONTENT FUNDING AND DISTRIBUTION” filed on Aug. 8, 2016 which claims the benefit of and priority to U.S. provisional patent application Ser. No. 62/202,848, titled “SYSTEM AND METHOD FOR MICROSHARE BASED PRODUCT/CONTENT FUNDING AND DISTRIBUTION” filed on Aug. 9, 2015, the entire specifications of each of which is incorporated herein by reference in their entirety.

### FIELD OF INVENTION

This invention relates generally to a system and method for enhancing digital media by embedding property rights into media using a digital signature infrastructure, so as to enable the creation of limited edition digital memorabilia in the form of media content.

### BACKGROUND OF INVENTION

Currently there is a rapid growth of mobile and internet adaption around the world. About 33% of the world's population has access to the Internet and, according to the United Nations, approximately 85 percent have access to a mobile phone. This growth in mobile and internet adoption is opening up the ability to target new untapped markets for product, services and content creators around the world. At the same time this growth has led to a surge in the amount of content, products and services being created, it is becoming increasingly difficult for the service providers and content/product makers to reach their target audience. In this circumstance, new and improved models for incentivizing consumer participation are becoming more important than ever for the success of these services and product/content projects both online and offline.

What is needed is a system and method for enhancing digital media by embedding property rights into media using a digital signature infrastructure, so as to enable the creation of limited edition digital memorabilia in the form of media content. Such a system/method allows for incentivizing consumers through equity or profit sharing by awarding them a small share in profit or equity of a project (also referred to as microshares): (1) When the consumer initiates a desired transaction—one of many possible example transactions would be, when the consumer subscribes to or purchases or rents, a product or content or service; or (2) when a specific condition or criteria is satisfied, also referred to as trigger events. Some example trigger events would be: when a consumer refers a new sale to the content/product or service, when 1 million copies of a content gets sold when a new user signup occurs for a service.

### SUMMARY OF INVENTION

In some embodiments, such a system would utilize, preferably, but without limitation, the internet or a blockchain or both to create a platform, where trigger events and user initiated transactions generates microshares that the users can trade with each other. Transforming these user initiated transactions and trigger events into tradable assets.

In some embodiments, the transactions or the trigger events might happen remotely on another platform or other offline sources, and might be communicated to the incentivization platform through API calls that might result in the generation of these micro shares.

A microshare may represent the future revenue rights and other rights associated with that specific transaction or the trigger event that lead to the awarding of that microshare. The future revenue rights associated with the microshare may be defined by an associated incentivization model.

Additionally, the microshares may be represented in the form of digital assets, a form of digital tokens that are held by the consumer either directly on the platform, or as user defined tokens that live on the blockchain. This would allow the consumer to trade these microshares with other users either directly on the platform or on a blockchain or on some other platform, essentially converting these transactions and trigger events into unique tradable assets. The terms digital assets may refer to a tokenized representation of microshares; both these terms may be used interchangeably throughout the rest of this document.

Also note that other form of digital representations of microshares might also be possible, including but not limited to various forms of gamification elements such as badges and points, and other variations of tokenized representations. All these representations shall be collectively referred to as digital assets in the rest of this document.

In case of digital assets representing a purchase transaction, the digital asset might be represented as a token that exists separately from the content/product that was purchased, or it might be incorporated directly into the digital content/product using a suitable form of metadata, or any combination of the above mentioned two approaches might also be implemented. Similarly, for a physical product, the digital asset might be issued as a separate token or could be directly embedded into the physical product using suitable means and methods.

The pieces of content or the products or the services that get listed on the platform may also collectively be referred to as projects, in the rest of the document. Content might refer to any form of online or offline content including but not limited to: video content such as short films, movies, TV episodes, and the like; audio content such as music, albums, audio books and any other forms of audio content; real time media content such as games, virtual reality, augmented reality and any other forms of real time media; software content such as apps, applications; gamification elements such as digital items that are part of games; visual media such as images, paintings and other forms of visual media; physical forms of content such as books, magazines and newspapers and the like; online and offline sale of event tickets.

The term product might refer to any form of physical product or component that can be manufactured and sold.

The term services might refer to any form of online or offline service that may get listed on the platform including, but not limited to, SaaS platforms.

The projects listed on the platform might be at any stage of their lifecycle: (i) including finished products, content and readily available services that may be just looking to do incentivized distribution; (ii) projects that may be in very early stages of their life cycle with only a simple pitch. These projects may need to raise funding so the idea can be turned into a finished product, content or services before being distributed; (iii) or projects that may be at some stage in between (i) and (ii)

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an overview of an embodiment of the conceptual architecture of the incentivization platform.

FIG. 2 is a blockchain based embodiment of the conceptual architecture of the incentivization platform.

FIG. 3 is a block diagram depicting an exemplary client/server system which may be used by an exemplary web-enabled/networked embodiment of the present invention; and

FIG. 4 illustrates a block diagram depicting a conventional client/server communication system.

FIG. 5 is an illustration of an exemplary method for the creation and listing of a project on the incentivization platform, in accordance with an embodiment of the present invention.

FIG. 6 is an illustration of an exemplary method showing a series of actions that result in the generation of a microshare, in accordance with an embodiment of the present invention.

FIG. 7 is an illustration of an exemplary method showing a series of actions that result in the generation of a microshare, in accordance with an alternate embodiment of the present invention involving blockchain.

FIG. 8 is an illustration of an exemplary method showing a series of actions that result in a real-time generation of a microshare, in accordance with an alternate embodiment of the present invention involving blockchain.

FIG. 9 is an illustration of an exemplary method for payment distribution on the incentivization platform, in accordance with an embodiment of the present invention.

FIG. 10 illustrates a block diagram depicting an exemplary implementation of the bitcoin blockchain, which may be used by an exemplary embodiment of the present invention.

FIG. 11 illustrates an overview of the conceptual architecture of digital assets on the bitcoin blockchain, which may be used by an exemplary embodiment of the present invention.

FIG. 12 illustrates a block diagram depicting an exemplary implementation of a social contract for a television series project on the incentivization platform, which may be used in an exemplary embodiment of the present invention.

FIG. 13 illustrates a block diagram depicting an exemplary implementation of voting on the bitcoin blockchain, which may be used by an exemplary embodiment of the present invention.

FIG. 14 illustrates a block diagram depicting an exemplary implementation of gamification elements on the incentivization platform, which may be used by an exemplary embodiment of the present invention.

FIG. 15 is an illustration depicting an exemplary implementation of a project for selling event tickets on the platform, which may part of an exemplary embodiment of the present invention.

FIG. 16 is an illustration depicting an exemplary implementation of a project for incentivizing subscription or signups to a SAAS platform, which may be part of an exemplary embodiment of the present invention.

FIG. 17 is an illustration depicting an exemplary implementation of a methodology for incentivizing user signup and subscriptions on the platform, which may be part of an exemplary embodiment of the present invention.

FIG. 18 illustrates a block diagram depicting an exemplary implementation of a digital signature infrastructure, which may be used by an exemplary embodiment of the present invention.

FIG. 19, FIG. 20 illustrate exemplary implementations of this invention combined with a digital signature infrastructure (as depicted in FIG. 18) to issue limited edition copies of the content that are digitally signed by the authors/creators to commemorate an event or a special moment.

FIG. 21, FIG. 22 illustrate exemplary implementations of this invention combined with a digital signature infrastructure (as depicted in FIG. 18) to issue limited edition copies of the content that are digitally signed by the authors/creators, who are winners/entrants in a contest.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a special purpose computer; a supercomputer; a mainframe; a super mini-computer; a mini-computer; a workstation; a micro-computer; a server; a client; an interactive television; a web appliance; a telecommunications device with internet access, including smartphones, tablets and other wearable technologies collectively also referred to as “web enabled devices”; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored programmable instructions, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™,PHP, Javascript or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language, or similar programming languages. Blockchain specific scripting language might be used for implementing blockchain related functionality. Some examples of such scripting languages are the built-in scripting language used by the bitcoin protocol, or the scripting languages used by the overlay protocols such as Counterparty or Mastercoin protocols. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In computer programming, an application programming interface (API) is a set of routines, protocols, and tools for building software applications and deliver functionality to external users and platforms. An API expresses a software component in terms of its operations, inputs, outputs, and underlying types. An API defines functionalities that are independent of their respective implementations, which allows definitions and implementations to vary without compromising the interface.

Software as a service (SaaS; pronounced) is a software licensing and delivery model in which software is licensed on a subscription basis and is centrally hosted. It may also be referred to as “on-demand software”. SaaS is typically accessed by users using a thin client via a web browser. SaaS has become a common delivery model for many business applications, including office and messaging software, payroll processing software, DBMS software, management software, CAD software, development software, gamification, virtualization, accounting, collaboration, customer relationship management (CRM), management information systems (MIS), enterprise resource planning (ERP), invoicing, human resource management (HRM), talent acquisition, content management (CM) and service desk management. [5] SaaS has been incorporated into the strategy of all leading enterprise software companies. One of the biggest selling points for these companies is the potential to reduce IT support costs by outsourcing hardware and software maintenance and support to the SaaS provider

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a widearea network), wired networks, wireless networks, Blockchain and payment networks.

The Bitcoin Network is a decentralized global payment network. The token of value that exists on the Bitcoin network is called bitcoin, the cryptocurrency. The Bitcoin network is peer-to-peer; users can transact directly without needing an intermediary to mediate that transaction. Transactions are verified by network nodes and recorded in a public distributed ledger called the blockchain. The network of nodes are specialized computer systems that may be operated all over the world, that help validate the transactions on the bitcoin network. The nodes might in some cases be running on the standard client server architecture model or other in some case might be using a more specialized architecture or using some variation thereof.

A blockchain may be a distributed database that maintains a continuously growing list of data records that are hardened against tampering and revision, including the operators of the data store's nodes. The most widely known application of a block chain is the public ledger of transactions for the Bitcoin Network, although the concept blockchains can be implemented for any kind of decentralized record keeping system, as demonstrated by the use of blockchain in other alternate cryptocurrency networks such as Namecoin, Ethereum and NXT. Most of the well-known implementation of the blockchain are as a public ledgers of transactions, such that all the transactions ever recorded on the block chain is open to scrutiny and examination by anyone. Although it is very much possible to have other modified implementation of the blockchain including ones where the transaction recorded on the blockchain are kept private.

An implementation of a Blockchain may contains unique identifiers, often referred to as ‘Addresses’ which allows the users to send and receive various tokens between the various participants on the network. Although the exact implementation of this address mechanism might change between the different implementations of the blockchain.

In the bitcoin embodiment of the blockchain, the addresses are created and managed using a SHA-256 based public key—private key mechanism. The following is an example bitcoin address,

a. 1JArS6jzE3AJ9xZ3aFij1BmTcpFGgN86hA

Similar how a bank account allows one to send and receive money from others, the bitcoin address allows you to send and receive tokens from other users on the bitcoin network. Each time any of these tokens are sent from one bitcoin address to another, a transaction gets created on the bitcoin network. This transaction then gets validated by the network of peer nodes, to see if it is authentic. If confirmed to be authentic then the transaction gets permanently recorded on the blockchain, as part of the latest block.

Every Bitcoin address has a matching private key, where the bitcoin address itself acts as the public key. The private key is mathematically related to the Bitcoin address, and is designed so that the Bitcoin address can be calculated from the private key, but importantly, the same cannot be done in reverse. A transaction of tokens out of a bitcoin address can only be initiated by the owner of the private key.

Note that a bitcoin address may also be created and operated by computer programs often referred to as Smart Contracts. These smart contracts can control and operate their bitcoin addresses, in an autonomous manner based on certain conditions as defined by their programming logic. These smart contracts may be used to automate a lot of the transaction logic that may need to happen on the blockchain.

Although ‘bitcoin—the cryptocurrency’ is the primary token that gets transferred between users on the bitcoin network, the bitcoin blockchain can be used to issue and transact in a number of other user created tokens. These tokens can be collectively referred to as ‘Digital Assets’. The creation of these ‘Digital Assets’ on the bitcoin blockchain can be enabled by the use of an overlay network protocols (e.g. Counterparty, Mastercoin, Colored coins) or by the use of a number of other alternate techniques including but not limited to side chain implementations.

The Bitcoin blockchain has been used in a number of instances to explain principles and concepts throughout this document, as it is an exemplary embodiment of a blockchain. The use of blockchain and other related concepts must in no way be considered to be limited to the bitcoin blockchain. Any number of other related or totally different implementations of blockchain may be used by a valid embodiment of the present invention, including other alternate implementations of the blockchain such as NXT, Ethereum or other private blockchains.

A hash function or a hash algorithm may be any function that can be used to map one or more data inputs of arbitrary size into fixed or varying length data, such that the mapped data acts as a unique identifier for the input data. The values returned by a hash function can be referred to as hash values, hash codes, hash sums, unique hash identifiers or simply hashes. Some of the more common hashing functions that rely on cryptography include SHA1, SHA2, SHA256 and MD5. But hashing function can use a number of other techniques including non-cryptographic technologies, such as simple merging of all the data inputs, or even passing along the input data unaltered provided the input data is already unique.

Encryption is a process of coding information which could either be a file or mail message in into cipher text a form unreadable without a decoding key in order to prevent anyone except the intended recipient from reading that data. Decryption is the reverse process of converting encoded data to its original un-encoded form, plaintext.

A key in cryptography is a long sequence of bits used by encryption/decryption algorithms.

For example, the following represents a hypothetical 40-bit key:
00001010 01101001 10011110 00011100 01010101

A given encryption algorithm takes the original message, and a key (could be referred to as a private key), and alters the original message mathematically based on the key's bits to create a new encrypted message. Likewise, a decryption algorithm takes an encrypted message and restores it to its original form using one or more keys. When a user encodes a piece of information, another user cannot decode and read that piece of information without the decryption key (could be referred to as a public key). Through this mechanism one can add a digital signature to digital content/information, such that it acts as a form of personal authentication, ensuring the integrity of the original message. To encode plaintext, an encryption key is used to impose an encryption algorithm onto the data. To decode cipher, a user must possess the appropriate decryption key. A decryption key consists of a random string of numbers, from 40 through 2,000 bits in length. The key imposes a decryption algorithm onto the data. This decryption algorithm reverses the encryption algorithm, returning the data to plaintext. The longer the encryption key is, the more difficult it is to decode. For a 40-bit encryption key, over one trillion possible decryption keys exist.

There are two primary approaches to encryption: symmetric and public-key (or asymmetric). Symmetric encryption is the most common type of encryption and uses the same key for encoding and decoding data. This key is known as a session key. Public-key (or asymmetric) encryption uses two different keys, a public key and a private key. One key encodes the message and the other decodes it. The public key is widely distributed while the private key is secret. Some examples of popular symmetric key algorithms, AES, 3DES modes along with the original DES algorithm and its block cipher modes. Some examples of public-key (or asymmetric) encryption algorithms include, DSS, RSA, ECDSA.

Aside from key length and encryption approach, other factors and variables impact the success of a cryptographic system. For example, different cipher modes, in coordination with initialization vectors and salt values, can be used to modify the encryption method. Cipher modes define the method in which data is encrypted. The stream cipher mode encodes data one bit at a time. The block cipher mode encodes data one block at a time. Although block cipher tends to execute more slowly than stream cipher, block. Encryption may be used to implement a digital signature mechanism used to prove authenticity in various scenarios.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer™, Safari™, FireFox™, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and any claims in this application or of any further Application derived therefrom, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and any claims in this application or of any further Application derived therefrom, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The terms consumer and user has been used interchangeably in this document. Also the terms revenue share and profit share have been used interchangeably to refer to the microshare holder's share of the payment.

Some embodiments of the present invention may provide systems and methods for incentivizing consumers through equity or profit sharing by awarding them a small shares in profit or equity of a project(also referred to as microshares): (1) when the consumer initiates a desired transaction—One of many possible example transactions would be, when the consumer subscribes to or purchases or rents, a product or content or service; or) 2) when a specific condition or criteria is satisfied, also referred to as trigger events. Some example trigger events would be, when a consumer refers a new sale to the content/product or service, when 1 million copies of a content gets sold, or when a new user sign up occurs for a service.

Such a system would utilize, preferably, but without limitation, the internet to create a platform, where trigger events and user initiated transactions generates micro shares that the users can trade with each other. In some embodiments, the transactions or the trigger events might happen remotely on another platform or other offline sources, and might be communicated to the incentivization platform through API calls that might result in the generation of microshares.

In some embodiments, the platform itself can be implemented completely using a client server architecture on a network such as the internet or equivalent variations. In alternate embodiments, parts of the platform could be implemented on a blockchain such as the bitcoin blockchain or other alternate blockchains, using smart contracts that implement a number of the described functionality directly on the blockchain. In some embodiments a frontend for the system might be implemented using the client server architecture, while the backend functionality is implemented on a blockchain. In some embodiments, the platform might not have a frontend and all the desired functionalities of the platform might be implemented only as APIs. In other alternate embodiments, the APIs might exist in addition to a frontend. There can also be embodiments of the platform where entire platform is implemented on a blockchain, using a series of smart contracts or other such equivalent mechanisms.

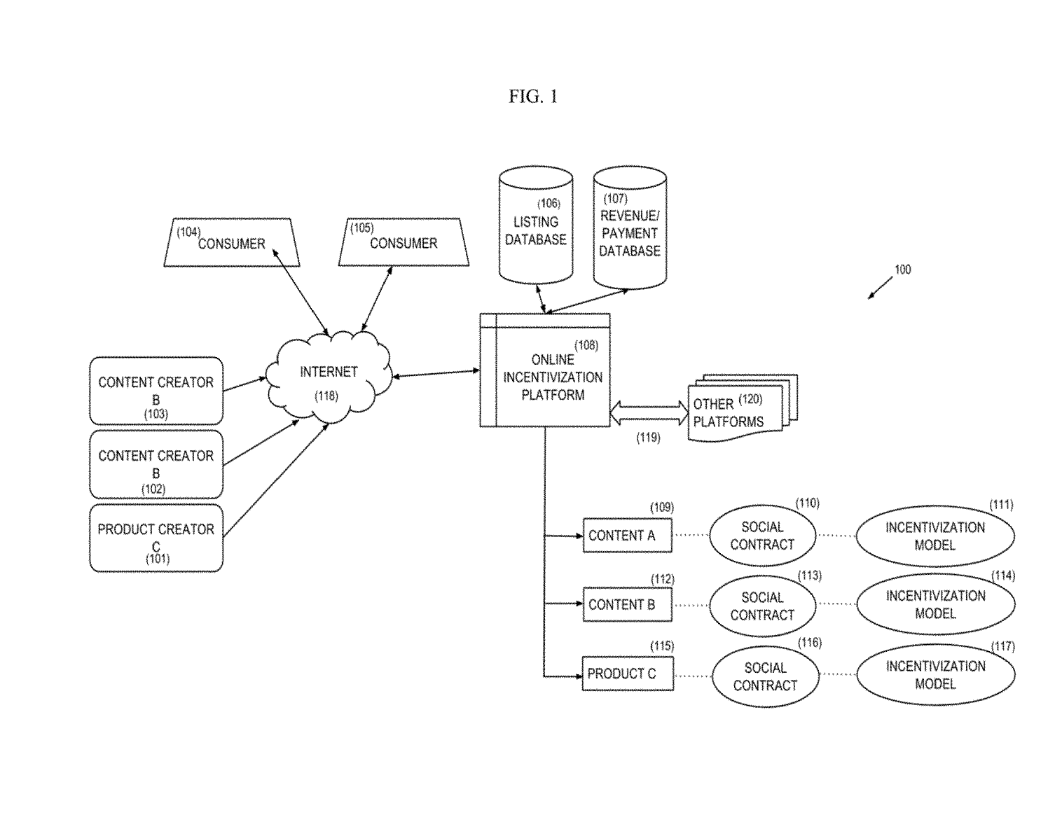

FIG. 1 is an overview of an embodiment of the conceptual architecture of the incentivization platform; One embodiment of the platform may be implemented completely using a client server architecture on a network such as the internet or equivalent variations. In one such embodiment, content and product projects would get listed on the platform 109, 112, 115. Each of the projects may have an associated social contract that describes the various payment and other rights associated with being a microshare owner in that project 110, 113, 116. Microshares in a project is a term used to refer to any future payment rights or other rights, awarded to the consumer based or a specific transaction or when a specific condition is satisfied, where the details of these rights may be determined by the incentivization model associated with the project. Incentivization model 111, 114, 117 refers to the payment or equity distribution model based on which the microshares of a given project may be distributed to consumers 104, 105. Depending on the needs of a project, the incentivization model may be setup to be as simple or as complex as needed. A social contract may be associated with a project to explain the various payment and other rights, including the incentivization models associated with the project. Aspects of the social contract might be implemented using smart contracts or using programing logic, either on the blockchain or on the platform itself or using a combination of both, also there might be aspects that require manual intervention and oversight as well. Even though the terms like social contract and incentivization models are described as distinct elements on some embodiments of the platform, they might not always be such distinct elements in other alternate embodiments of the platform. They could be mixed together into a single element or may be broken down into other granular elements or might exist in various other forms and formats.

A project creator 101, 102, 103 who may be interested in listing a project may access the platform on a computer or other equivalent web enabled devices and then setup and launch the project on the platform without need an audit and verification step, or in an alternate embodiment the project creator might apply to get his or her project listed on the platform, only after an audit and verification step would the project get listed on the platform. There can be valid embodiments of the platform where the content creator is able to define and assemble the various aspects of a project and get it listed all by herself. While in other alternate embodiments, he or she might get help from experts who help assemble and setup the various components of the project for her or provide help for the project creators to do it themselves, or any combination in the middle. Consumers may access the platform using a computer or other equivalent web enabled devices and initiate a transaction on any of the listed projects. A transaction may be imitated through any number of user actions, including, but not limited to

purchasing a product or content or service

renting or subscribing to a product or content or service

When a user (also referred to as consumer) initiated transaction occurs, based on the social contract associated with that project, the transaction might generate a micro share that represents the future revenue and other rights associated with that specific transaction.

In some embodiments of the platform, certain ‘trigger events’ defined by a project might generate microshares for a specific user, based on his or her actions, for example when the user's promotional efforts result in a new sale of a product or content, or service, that might lead to that user being awarded a microshare for that project. There might also be cases when microshares might be awarded to a user without the user needing to take any action on his or her behalf, such as when bonus micro shares might get awarded to all the previous microshare holders of a project, when a milestone such as when 1 million copies of a project gets sold.

In some embodiments of the platform the generated microshares may be stored and tracked completely on the platform with the help of databases and the platform keeps track of the ownership and the future rights associated with the micro shares and makes payment distributions as needed 107.

In some embodiments, the microshares might be represented as tokens (also referred to as Digital Assets) that exist completely within the platform. Users on the platform might be able to trade these micro shares with one another.

In some embodiments of the platform, the users may be able to export theses tradable digital assets 119 out of the described incentivization platform 108 and onto other platforms 120 or blockchains.

In some embodiments of the platform, APIs might exist that allows other platforms to use the incentivization platform to generate microshares and/or its digital asset representation and directly import it into their platform or on to a blockchain 120.

Some valid embodiments of the platform may also include various gamification elements, including but not limited to various titles and badges that are used to encourage user participation both at the platform level and in the various projects listed on the platform. These gamification elements may be implemented such that each of these gamification elements is tied to a digital asset that receives future payment distribution and other associated rights. The users may also be able to trade these digital assets with other users so that they may be able to sell these payment and other rights associated with these gamification elements to other users.

In some valid embodiments of the platform, a user may be able to sell just the payment or other rights associated with a gamification element, while still being able to hold on to the gamification element, or they may be able to sell the gamification element along with the payment and other rights associated with the digital asset that represents the gamification element. These two and other embodiments are possible depending on how closely the gamification element and the associated digital asset representing its associated payment and other rights are tied together in the implementation of the embodiment.

In some embodiments of the platform, the social contract associated with a project may define the future profit share associated with any specific microshare. The frequency of profit distribution may also be defined by the terms on the social contract. In some embodiments of the platform, the profit distribution might happen in real time, i.e. as soon as revenue rolls into the project. In other embodiments, the payment distribution might happen at specific time intervals as defined by the terms of the social contract. In some embodiments, the payment distribution can be setup to happen entirely within the platform. So when the revenue distribution happens, the revenue share of each micro share would be sent to the account of the user holding that micro share at that time.

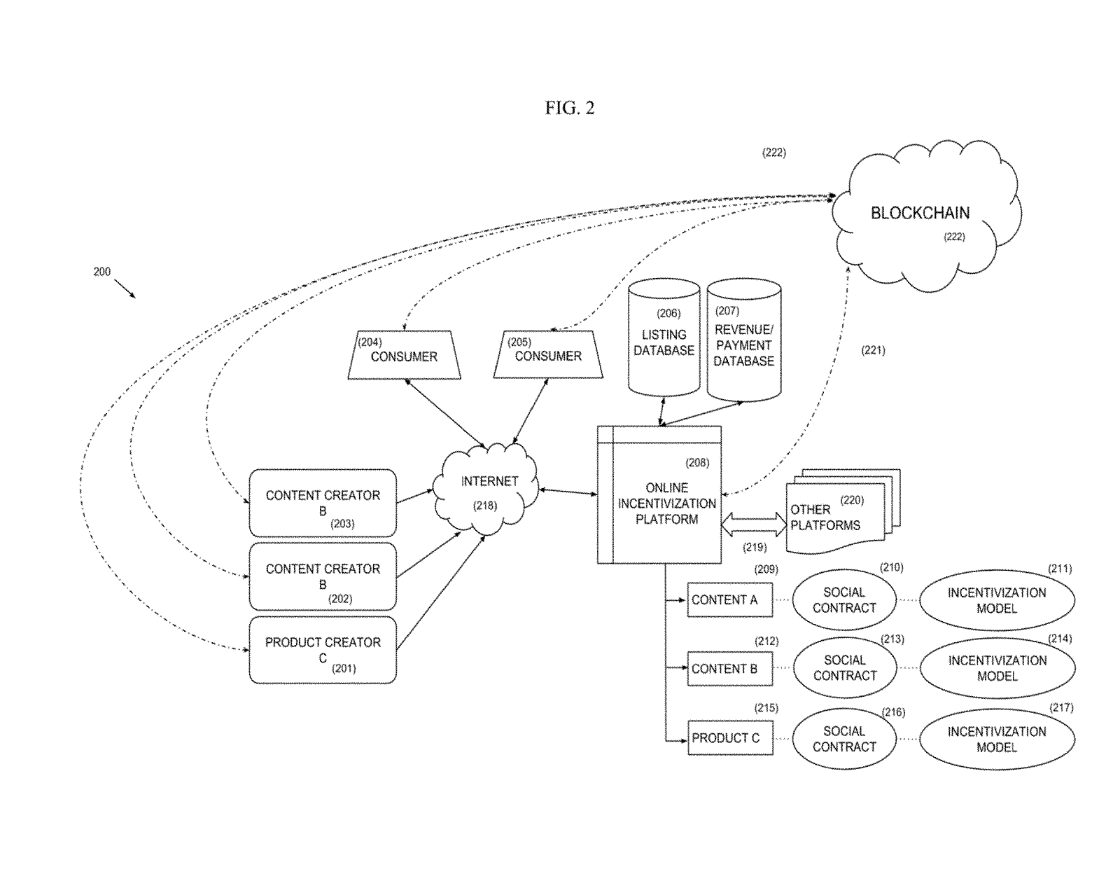

FIG. 2 is a blockchain based embodiment of the conceptual architecture of the incentivization platform. This embodiment extends the embodiment of the platform described in FIG. 1 in various aspects by incorporating blockchain.

In one such embodiment, the digital assets representing the microshares could be directly issued on to one of many blockchains 221.

In another alternate embodiment, the digital assets could initially be issued directly on the platform without using a blockchain, with an option for users to export them out on to a blockchain at a later date if they desire to do so, or any combination of the above mentioned two approaches is also possible 221.

In an alternate embodiment, the payment distribution may be implemented entirely on the blockchain, so that depending on whichever blockchain is used for the payment distribution, the profit share of each of the digital asset can be distributed to the appropriate addresses holding those digital assets or directly to the users holding those assets, whichever functionality is better supported by that specific implementation of the blockchain. The payment distribution on the blockchain may be initiated by running the appropriate commands supported by the blockchain and any of the associated protocols or by any other supported means. A combination of on the platform and on the blockchain distribution might also be possible for embodiments where some of the microshares are exported as digital assets on to the blockchain while some of the microshares are still held on the platform 222, 221.

In some embodiments, parts of the platform may be implemented on a blockchain such as the bitcoin blockchain or other alternate blockchains, using smart contracts that implement a number of the functionalities of the platform directly on the blockchain. In some embodiments a frontend for the system might be implemented using the client server architecture, while the backend functionality is implemented on a blockchain 221. There can also be embodiments of the platform where entire platform is implemented on a single or multiple blockchain, using a series of smart contracts or other such equivalent mechanisms.

In some embodiments, the platform might not have a frontend and all the desired functionalities of the platform might be implemented only as APIs. In other alternate embodiments, the APIs might exist in addition to a frontend.

Without any limitation, the blockchain could be the bitcoin blockchain or any number of other related or totally different implementations of blockchain may be used by a valid embodiment of the present invention, including other alternate implementations of the blockchain such as NXT, Ethereum or other private blockchains.

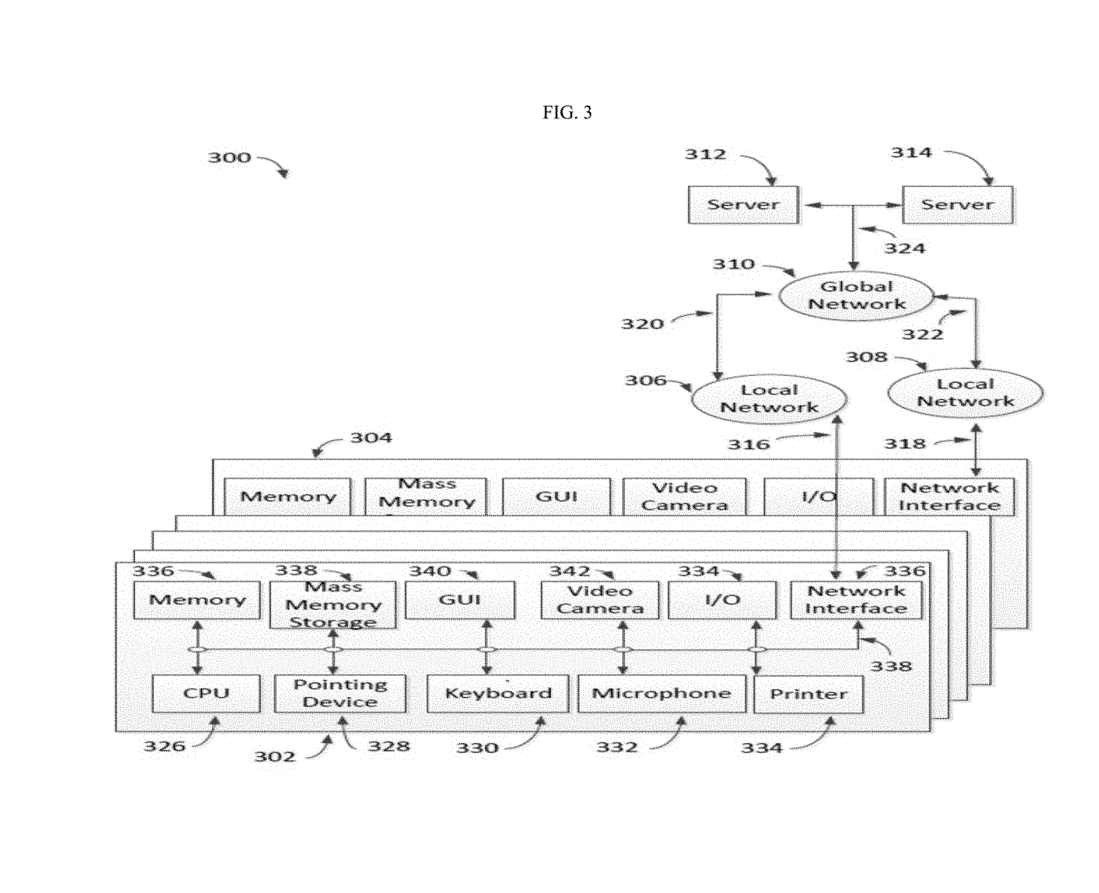

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

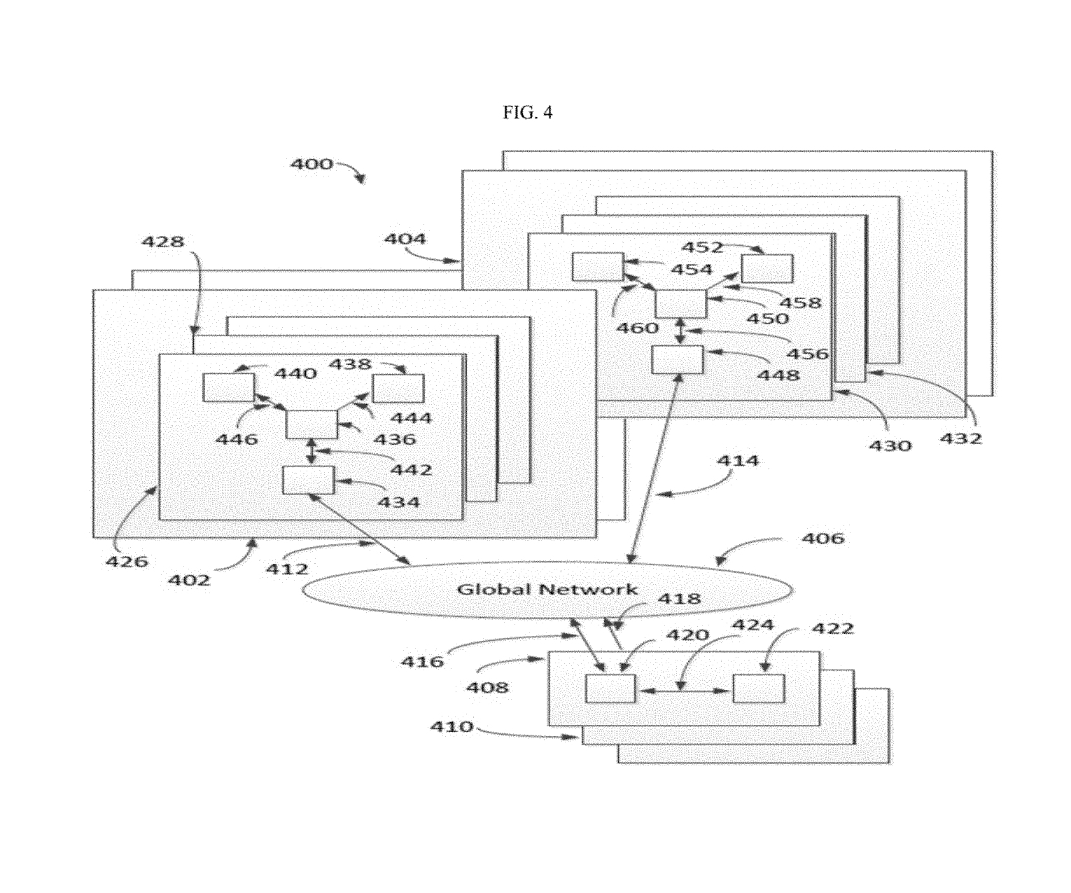

FIG. 4 illustrates a block diagram depicting a conventional client/server communication system.

A communication system 400 includes a multiplicity of networked regions with a sampling of regions denoted as a network region 402 and a network region 404, a global network 406 and a multiplicity of servers with a sampling of servers denoted as a server device 408 and a server device 410.

Network region 402 and network region 404 may operate to represent a network contained within a geographical area or region. Non-limiting examples of representations for the geographical areas for the networked regions may include postal zip codes, telephone area codes, states, counties, cities and countries. Elements within network region 402 and 404 may operate to communicate with external elements within other networked regions or within elements contained within the same network region.

In some implementations, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

Server device 408 and server device 410 may operate to execute software instructions, store information, support database operations and communicate with other networked elements. Non-limiting examples of software and scripting languages which may be executed on server device 408 and server device 410 include C, C++, C# and Java.

Network region 402 may operate to communicate bi-directionally with global network 406 via a communication channel 412. Network region 404 may operate to communicate bi-directionally with global network 406 via a communication channel 414. Server device 408 may operate to communicate bi-directionally with global network 406 via a communication channel 416. Server device 410 may operate to communicate bi-directionally with global network 406 via a communication channel 418. Network region 402 and 404, global network 406 and server devices 408 and 410 may operate to communicate with each other and with every other networked device located within communication system 400.

Server device 408 includes a networking device 420 and a server 422. Networking device 420 may operate to communicate bi-directionally with global network 406 via communication channel 416 and with server 422 via a communication channel 424. Server 422 may operate to execute software instructions and store information.

Network region 402 includes a multiplicity of clients with a sampling denoted as a client 426 and a client 428. Client 426 includes a networking device 434, a processor 436, a GUI 438 and an interface device 440. Non-limiting examples of devices for GUI 438 include monitors, televisions, cellular telephones, smartphones and PDAs (Personal Digital Assistants). Non-limiting examples of interface device 440 include pointing device, mouse, trackball, scanner and printer. Networking device 434 may communicate bi-directionally with global network 406 via communication channel 412 and with processor 436 via a communication channel 442. GUI 438 may receive information from processor 436 via a communication channel 444 for presentation to a user for viewing. Interface device 440 may operate to send control information to processor 436 and to receive information from processor 436 via a communication channel 446. Network region 404 includes a multiplicity of clients with a sampling denoted as a client 430 and a client 432. Client 430 includes a networking device 448, a processor 450, a GUI 452 and an interface device 454. Non-limiting examples of devices for GUI 438 include monitors, televisions, cellular telephones, smartphones and PDAs (Personal Digital Assistants). Non-limiting examples of interface device 440 include pointing devices, mousse, trackballs, scanners and printers. Networking device 448 may communicate bi-directionally with global network 406 via communication channel 414 and with processor 450 via a communication channel 456. GUI 452 may receive information from processor 450 via a communication channel 458 for presentation to a user for viewing. Interface device 454 may operate to send control information to processor 450 and to receive information from processor 450 via a communication channel 460.

For example, consider the case where a user interfacing with client 426 may want to execute a networked application. A user may enter the IP (Internet Protocol) address for the networked application using interface device 440. The IP address information may be communicated to processor 436 via communication channel 446. Processor 436 may then communicate the IP address information to networking device 434 via communication channel 442. Networking device 434 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 424. Server 422 may receive the IP address information and after processing the IP address information may communicate return information to networking device 420 via communication channel 424. Networking device 420 may communicate the return information to global network 406 via communication channel 416. Global network 406 may communicate the return information to networking device 434 via communication channel 412. Networking device 434 may communicate the return information to processor 436 via communication channel 442. Processor 446 may communicate the return information to GUI 438 via communication channel 444. User may then view the return information on GUI 438.

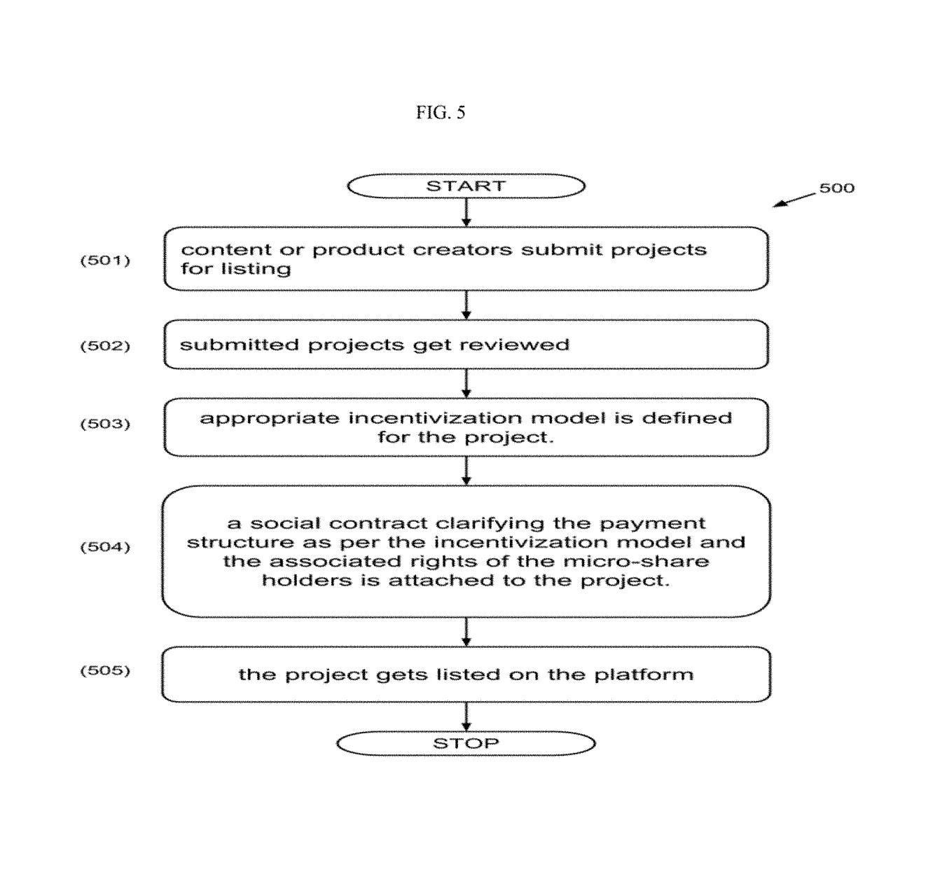

FIG. 5 is an illustration of an exemplary method for the creation and listing of a project on the incentivization platform, in accordance with an embodiment of the present invention;

A project creator who may be interested in listing a project may access the platform on a computer or other equivalent web enabled devices. There may be embodiments of the platform, in which the project creator might apply to get his or her project listed on the platform 501, only after an audit and verification step (review) would the project get listed on the platform 502. There may be valid embodiments of the platform where the content creator is able to define and assemble the various aspects of a project including the incentivization model and the social contract 503, 504, and get it listed all by herself. While in other alternate embodiments, he or she might get help from experts who help assemble and setup the various components of the project for her or provide help for the project creators to do it themselves, or take a combination of the two approaches.

In an alternate embodiment of the platform, the project creators might be able to setup and launch the project on the platform without the need for an audit and verification step.

There might be alternate embodiments in which any of the above steps might be accomplished remotely through API calls.

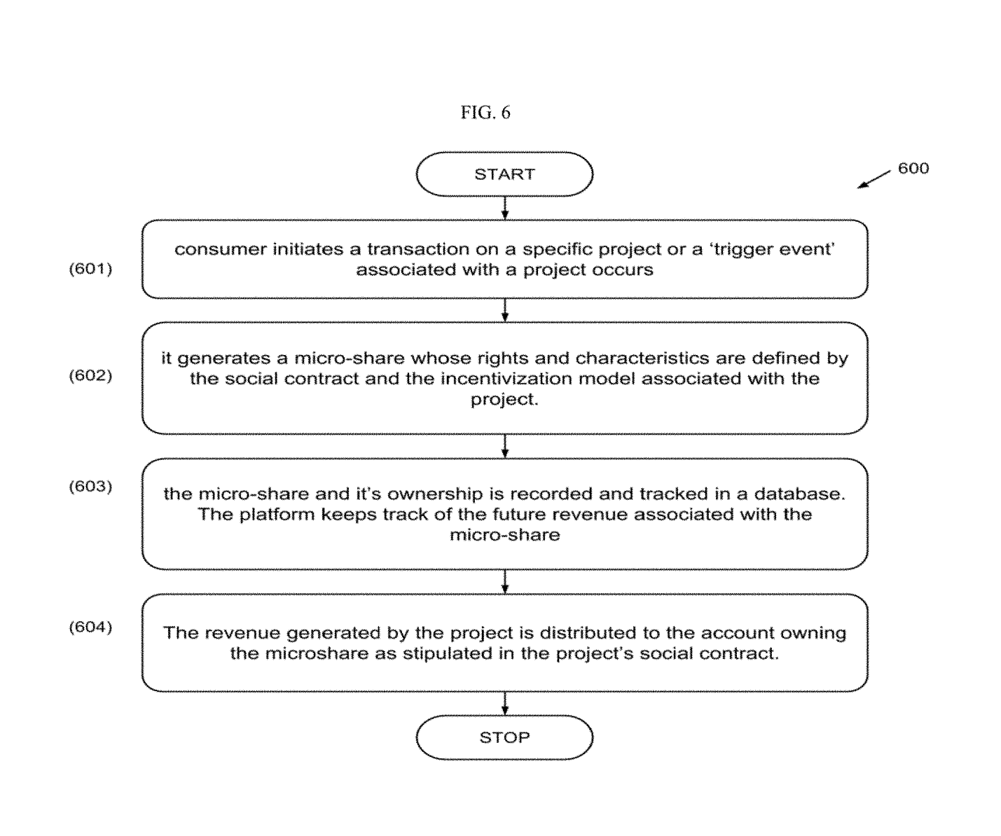

FIG. 6 is an illustration of an exemplary method showing a series of actions that result in the generation of a microshare, in accordance with an embodiment of the present invention;

In one embodiment of the platform, a consumer might initiate a transaction through an action such as buying or renting a product or content or service listed on the platform or a trigger event related to a project might occur 601. In alternate embodiments, the transaction or the trigger event might happen remotely on another platform or other offline sources, and might be communicated to the incentivization platform through API calls. Then based on the social contract and the incentivization model associated with that project, the transaction or the trigger event might generate a microshare that represents the future revenue and other rights associated with that specific transaction 602. In this embodiment, the microshare may be generated as a digital asset that may be awarded to the recipient's user account. In this embodiment, all aspects of microshare and digital asset generation, distribution and tracking are stored and managed by the platform itself using databases, without the use of any blockchains 603. The platform also manages the payment distribution to the various microshare holders based on the social contract of their corresponding project and distributes payments to the recipient user account based on their micro share ownership 604.

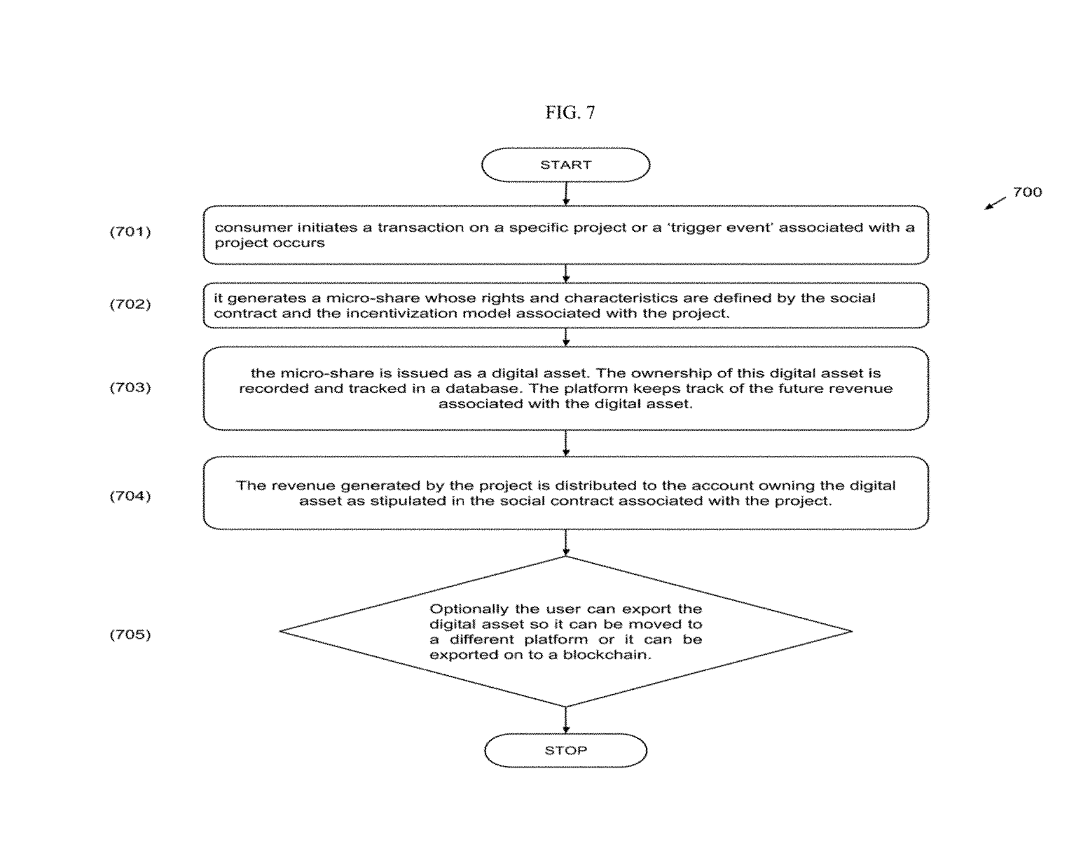

FIG. 7 is an illustration of an exemplary method showing a series of actions that result in the generation of a microshare, in accordance with an alternate embodiment of the present invention involving blockchain.

In an alternate embodiment, a consumer might initiate a transaction through an action such as buying or renting a product or content or service listed on the platform or a trigger event related to a project might occur 701. In alternate embodiments, the transaction or the trigger event might happen remotely on another platform or other offline sources, and might be communicated to the incentivization platform through API calls. Then based on the social contract and the incentivization model associated with that project, the transaction or the trigger event might generate a microshare that represents the future revenue and other rights associated with that specific transaction 702. The microshare may be generated as a digital asset that may be awarded to the recipient's user account. In this embodiment, all aspects of microshare and digital asset generation, distribution and tracking are stored and managed by the platform itself using databases 703. The platform also manages the payment distribution to the various microshare holders based on the social contract of their corresponding project and distributes payments to the recipient user account based on their microshare ownership 704. The platform might also have an additional option to export the digital assets onto other supported blockchains and platforms 705.

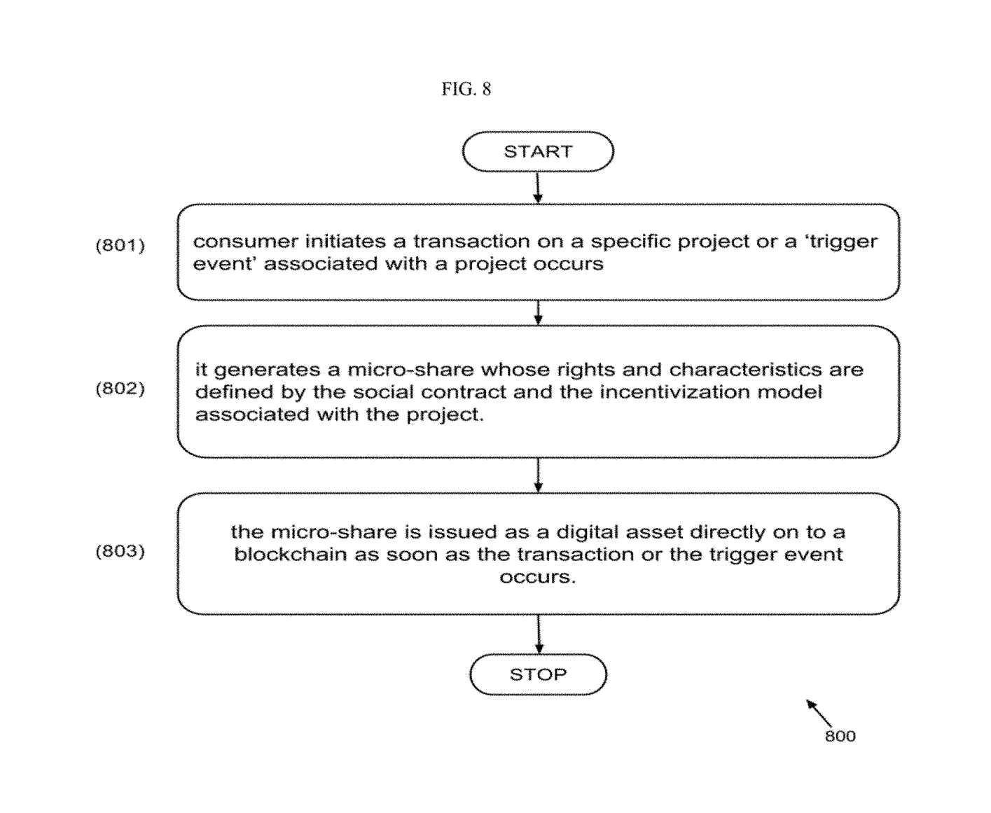

FIG. 8 is an illustration of an exemplary method showing a series of actions that result in a real-time generation of a microshare, in accordance with an alternate embodiment of the present invention involving blockchain;

In an alternate embodiment, a consumer might initiate a transaction through an action such as buying or renting a product or content or service listed on the platform or a trigger event related to a project might occur 801. In alternate embodiments, the transaction or the trigger event might happen remotely on another platform or other offline sources, and might be communicated to the incentivization platform through API calls. Then based on the social contract and the incentivization model associated with that project, the transaction or the trigger event might generate a microshare that represents the future revenue and other rights associated with that specific transaction 802. In this embodiment, the digital assets representing the microshare might be issued directly on a blockchain in real-time as soon as the transaction or the trigger even occurs 803.

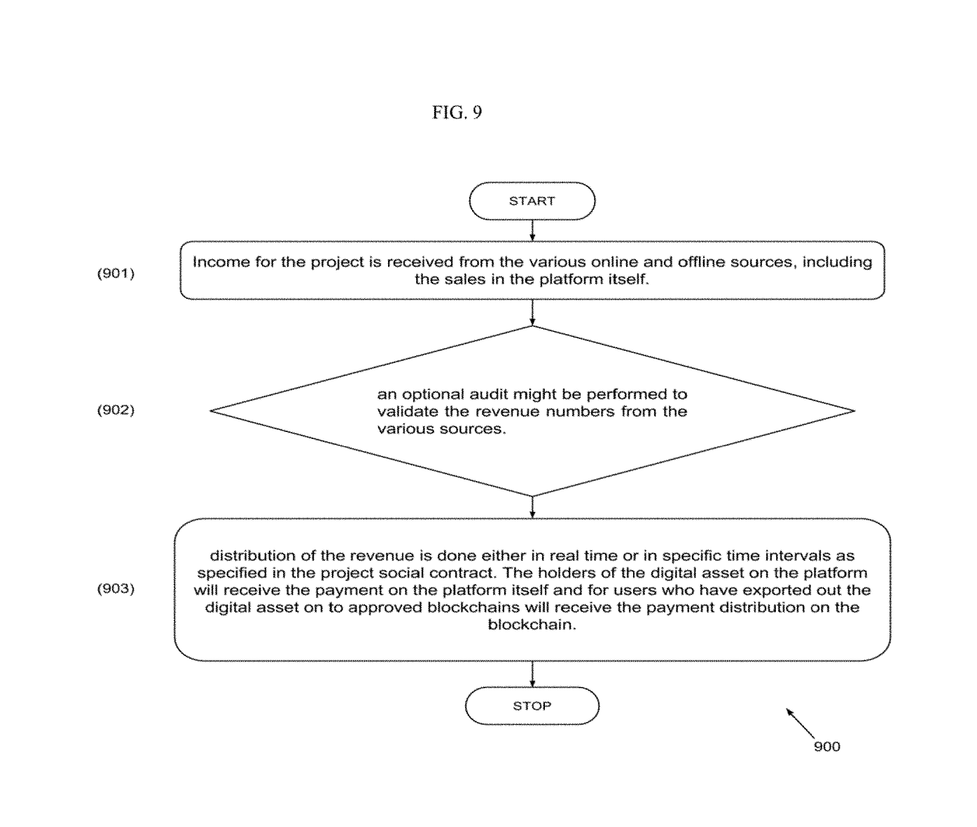

FIG. 9 is an illustration of an exemplary method for payment distribution on the incentivization platform, in accordance with an embodiment of the present invention;

In an embodiment of the platform, the revenue for a project may be generated through a number of online and offline sources which may include without limitation, sources such as in-store sales, merchandising revenue and revenue from sales on other platforms and online stores, etc., in addition to the revenue from the platform itself 901. The platform might implement a manual or an automated audit process to verify the accuracy of the revenue numbers generated for any given project and then report the revenue from the various sources on the project page on the platform 902. The frequency of profit distribution may be defined by the terms on the social contract. In some embodiments of the platform, the profit distribution might happen in real time, i.e. as soon as revenue rolls into the project. In other embodiments, the payment distribution might happen at specific time intervals as defined by the terms of the social contract. In some embodiments, the payment distribution can be setup to happen entirely within the platform. So when the revenue distribution happens, the revenue share of each micro share would be sent to the account of the user holding that micro share at that time. In an alternate embodiment, the payment distribution may be implemented entirely on the blockchain, so that depending on whichever blockchain is used for the payment distribution, the profit share of each of the digital asset can be distributed to the appropriate addresses holding those digital assets or directly to the users holding those assets, whichever functionality is better supported by that specific implementation of the blockchain. The payment distribution on the blockchain may be initiated by running the appropriate commands supported by the blockchain and any of the associated protocols or by any other supported means. A combination of on the platform and on the blockchain distribution might also be possible for embodiments where some of the microshares are exported as digital assets on to the blockchain while some of the microshares are still held on the platform 903.

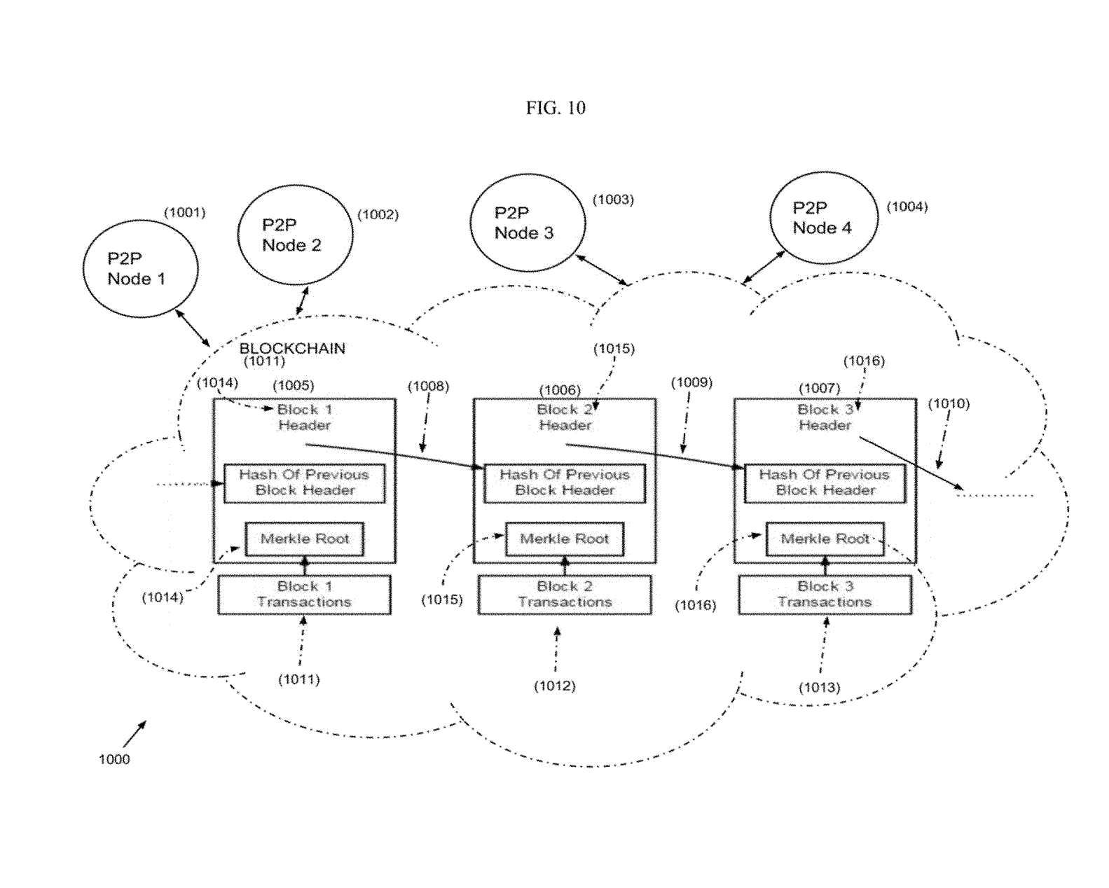

FIG. 10 illustrates a block diagram depicting an exemplary implementation of the bitcoin blockchain, which may be used by an exemplary embodiment of the present invention;

The blockchain may consist of a series of grouped together transactions called blocks 105, 106, 107, that may be that are linked to one another in a time linear manner 1008, 1009, 1010. One or more new transactions may be collected into the transaction data part of a block 1011, 1012, 1013. Copies of each transaction could be hashed, and the hashes could then be paired, hashed, paired again, and hashed again until a single hash remains, which could act as the merkle root of a merkle tree 1014, 1015, 1016. The merkle root could be stored in the block header 1014, 1015, 1016. Each block could also store the hash of the previous block's header, chaining the blocks together 1008, 1009, 1010. This means a transaction cannot be modified without modifying the block that records it and all following blocks. Chaining blocks together makes it impossible to modify transactions included in any block without modifying all following blocks. As a result, the cost to modify a particular block increases with every new block added to the blockchain. This system provides a robust way to prevent the tampering of the transactions on the Bitcoin blockchain. A blockchain may be collaboratively maintained by anonymous peers 1001, 1002, 1003, 1004 on the network, as parts of the bitcoin network are or the peers may not be anonymous in other alternate implementation of blockchains. The blockchain might be part of a global network, as in the case of bitcoin or other alternate configurations are also possible, where the network might be a local network or where the peers are not anonymous.

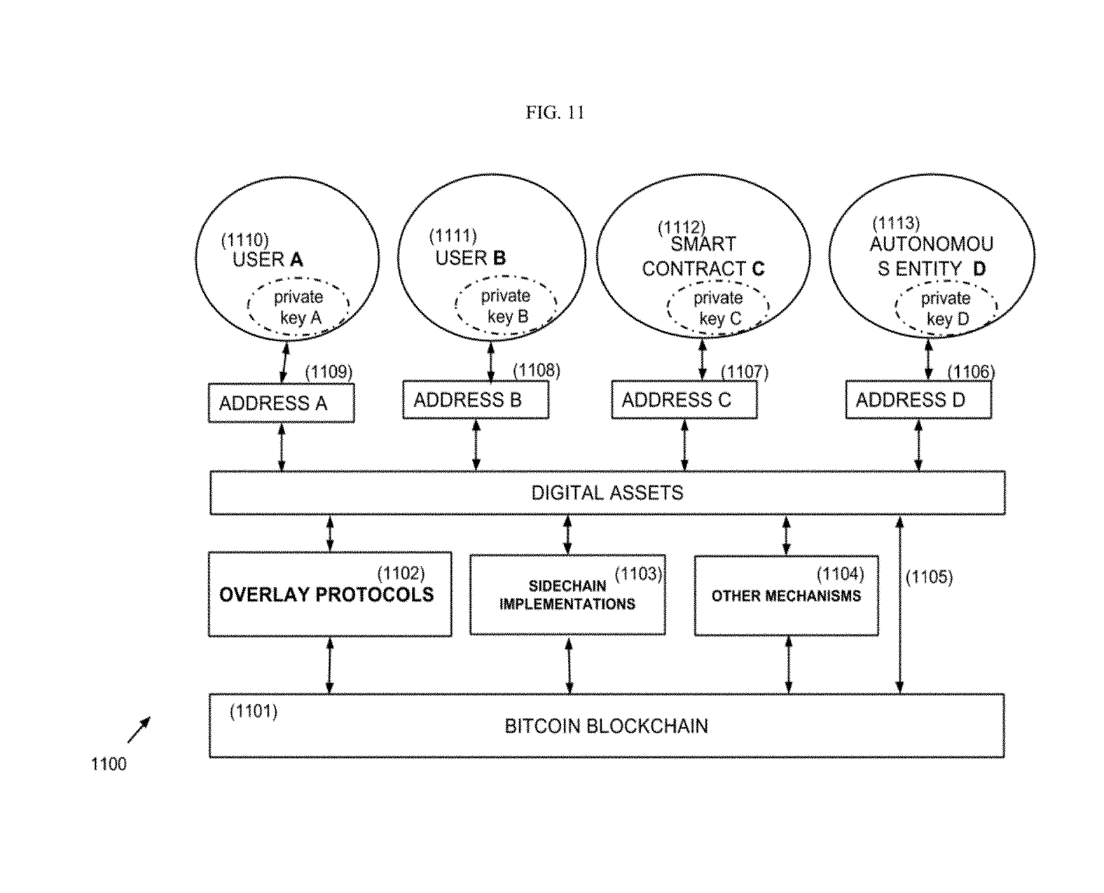

FIG. 11 illustrates an overview of the conceptual architecture of digital assets on the bitcoin blockchain, which may be used by an exemplary embodiment of the present invention;

One way to implement digital asset issuance on the bitcoin blockchain is by making use of an overlay protocol such as Counterparty, Colored Coin or Mastercoin 1102. Asset issuance commands of these protocols may be used to create digital assets.

For example, the following counterparty command issues a new digital asset named ‘BBBC’ and creates 100 of those assets. The asset is issued by the address specified by the ‘source’ flag, where the address is a valid bitcoin address.

issuance—source=mtQheFaSfWELRB2MyMBaiWjdDm6ux9Ezns—quantity=100—asset=‘BBBC’

The newly issued assets are stored in the source address by default. These assets may then be sent to various other addresses as desired. The right for future issuance of additional quantities of the ‘BBBC’ asset stays with the source address. For example, if we assume mtQheFaSfWELRB2MyMBaiWjdDm6ux9Ezns is ADDRESS A in FIG. 11 1109. Then USER A, who holds the private key for the ADDRESS A holds all the ‘BBBC’ at the beginning when they are issued. Later he may choose to distribute the ‘BBBC’ asset to ADDRESS B 1108, ADDRESS C [1107] and ADDRESS D 1106 by using the counterparty send command. Additional functionalities to distribute dividends to all the holders of a specific asset may also be available. For example, Counterparty supports a command called dividend, with the following syntax,
dividend—source=mtQheFaSfWELRB2MyMBaiWjdDm6ux9Ezns—quantity-per-share=1—asset=BBBC—dividend-asset USDPEG

The-source flag gives the source address which holds the funds with which the dividends are to be paid. The -dividend-asset flag gives the name of the asset which is used for the dividend payment, in this example, the payment digital asset is ‘USDPEG’. The-quantity-per-share flag gives the quantity of the above mentioned payment digital asset (USDPEG), that is to be paid to the holders of the BBBC digital asset. The quantity specified in the-quantity-per-share flag gives the number of USDPEG asset that needs to be paid for a single BBBC asset that an address holds.

When the dividend command is executed, the dividend is automatically distributed to all the addresses holding the BBBC asset on the network. Note that a bitcoin addresses can also be created by computer programs called smart contracts 1112. These smart contracts can control and operate their bitcoin addresses, in an autonomous manner based on certain conditions as defined by their programming logic. Also, autonomous machines such as those connected to the internet of things, might also be able to control and operate their own bitcoin addresses 1113.

This example illustrates just one method for the issuance of a digital asset (user defined tokens) and dividend distribution on the bitcoin blockchain. There are a number of other means and methods 1103, 1104, 1105 to issue a digital asset such as by using sidechain implementation or other suitable means. The syntax associated with the above mentioned commands may change from time to time as the protocol gets updated and new better mechanisms may emerge. In those cases, any of the above mentioned methods can be replaced with a suitable mechanism as needed. Alternate embodiments might have variations of this setup that may be implemented on other alternate blockchains and variations.

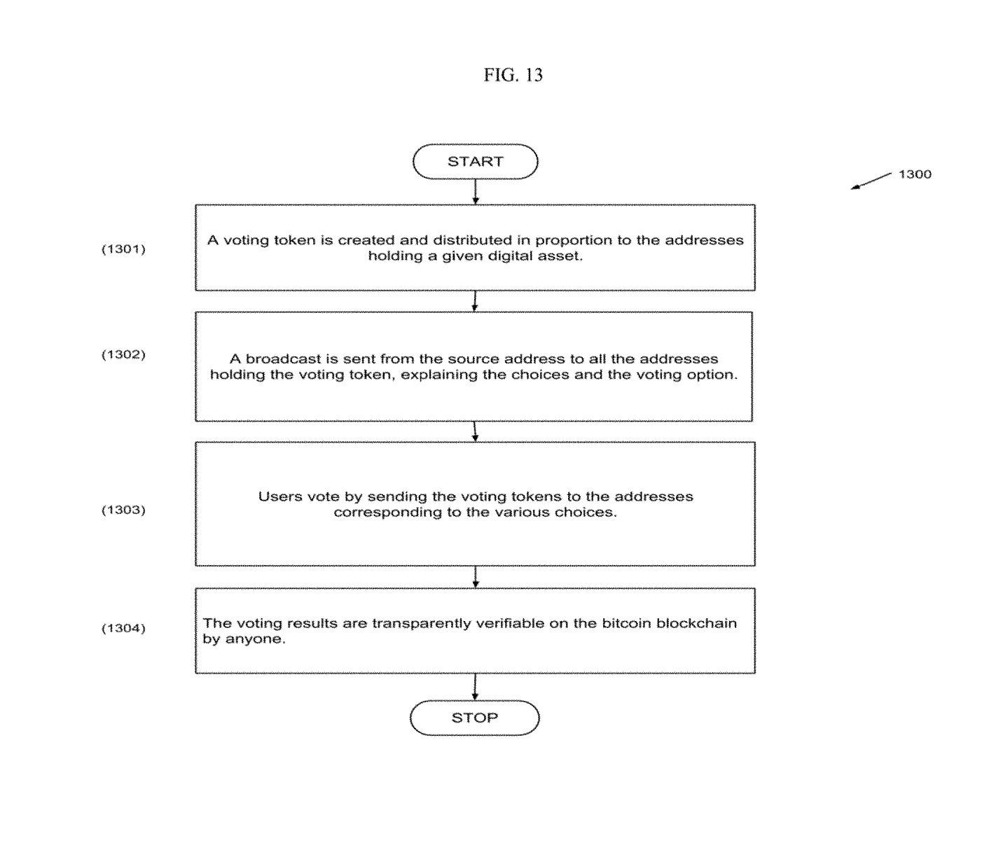

FIG. 13 illustrates a block diagram depicting an exemplary implementation of voting on the bitcoin blockchain, which may be used by an exemplary embodiment of the present invention;

One-way implement voting mechanism on the bitcoin blockchain is using an overlay protocol such as counterparty. Let us step through an embodiment of a voting mechanism that may be implemented on the bitcoin blockchain, using the counterparty overlay protocol. Counterparty supports voting through user-created tokens, also referred to as digital assets, as well as by broadcasting information onto the Bitcoin blockchain. This means that one can post the terms and options of a vote as a broadcast, and let users vote on its outcome with full transparency by using ‘voting’ digital assets.

In counterparty, a broadcast message publishes textual and numerical information, along with a timestamp 1302, as part of a series of broadcasts called a ‘feed’. One feed is associated with one address: any broadcast from a given address is part of that address's feed. The timestamps of a feed must increase monotonically.
broadcast—source=mtQheFaSfWELRB2MyMBaiWjdDm6ux9Ezns—text=“Description of the voting”—value=825.22—fee-multiplier=0.001
a.—source=the source address
b.—text=the textual part of the broadcast (set to ‘LOCK’ to lock feed)
c.—value=numerical value of the broadcast

As an example, if one creates a token (‘EXAMPLE’), you can create any other tokens (such as EXAMPLEVOTE) and pay distributions of EXAMPLEVOTE to all holders of EXAMPLE in one single action, using the dividend counterparty command 1301. Now all that is needed are as many different Bitcoin addresses as there are choices in the poll. To cast their votes, holders of EXAMPLE can then send the EXAMPLEVOTE 1303 they have received to whichever choice(s) they agree with. The results of the poll will be public and verifiable on the Bitcoin blockchain 1304.

The above example is just one way to implement the voting mechanism on the bitcoin blockchain, voting mechanisms can be implemented in a number of other means as well. The methods and implementation will change between different blockchain and overlay protocol, in some cases without there might not even be a need for any overlay protocols at all.

### Social Contracts

The following examples will illustrate how social contracts might be laid out for different projects, this section is intended as a way to give some examples to illustrate how a social contract might work for various kinds of projects on the various embodiment of the present invention. It should in no way be interpreted as limiting the scope of the kind of social contracts that may be deployed on the platform. If anything, these following examples represent a subset of the kind of contracts that could be deployed for projects on the platform.

An independent film seeking to incentivize its early sales and distribution may list itself on the platform and make use of a social contract that may have terms similar to the following,

A) All forms of revenue generated by this film project throughout its entire lifetime will flow into this address,

a. 15HCzh8AoKRnTWMtmgAsT9TKUPrQ6oh9HQ

(B) Each purchase of the movie will generate a microshare that has the rights to all the future profits that this movie generates once the initial costs are recouped by the filmmakers, the micro shares will be generated as digital assets.

(C) After the initial budget of $1,000,000 is recuperated, all the additional revenue will be split 25/75 between the filmmakers and the microshare holders. Distributions will be made on the last day of every calendar year automatically on the blockchain.

(D) The microshare will be awarded to the first 500,000 purchasers of the movie.

(E) Each copy of the movie will be priced at $10.00

(F) Each purchase of the movie would be entitled a microshare ranging between 0.0003% to 0.000075% of the future profit depending on when the copy was purchased. So the very first copy of the movie will get a 0.0003% revenue share while the 500,000th copy will get a revenue share of 0.000075%. The distribution will be made to the digital asset associated with the purchase.

(G) The participants in this early ‘Pay to Participate’ phase would be reserved 5% of the ‘revenue after cost’ in any derivative work of spinoffs from this project.

The following section illustrates and explores the various terms of this social contract in more detail,

### Point (A)

In the above described example, all the revenue generated by this project would be directed into the given bitcoin address (15HCzh8AoKRnTWMtmgAsT9TKUPrQ6oh9HQ). In alternate embodiments of the platform, the revenue might be flowing into an address on an alternate blockchain implementation, or the flow of funds could be tracked completely using a suitable implementation within the platform itself without making use of a blockchain. In alternate embodiments of the platform, the platform might implement additional audit and verifications steps to ensure that the revenue flowing into the project from the various on and offline sources are reported and updated accurately. These steps may include a combination of scripted programming logic and manual intervention accomplish this effectively.

### Point (B)

In this case, each purchase of the movie would generate a micro share, which would be represented as a unique digital asset that would have the rights to receive a small share in the future lifetime profits in the film, but the microshares could as easily be defined to possess other rights and attributes depending on the needs of the project. There might be cases where the microshares are directly awarded to the purchaser of the movie and are tracked as part of his account on the platform. Other alternate implementations might include scenarios where the microshares may be represented as a digital asset that can be either held or traded between users completely on the platform, or the digital assets can be issued directly on the blockchain and can be traded between users on the blockchain. Another alternative is that these digital assets can be issued and traded completely within the platform initially, with an option to export out the digital assets on to the blockchain at a later date if the user chooses to.

In some embodiments, incase two microshares have the same amount of payment rights associated with them, they may be considered fungible. On the other hand, the microshares might incorporate additional attributes that could differentiate them into various categories or make them unique, such as by incorporating the date and time of their issue, or a number of other attributes. These possible attributes could include, without limitation, gamification attributes such as,
being the first purchase of the movie copy,
being the 100th copy of a movie.
award for being a hardcore fan of the movie, or being the craziest binge watcher of the movie,
being the buyer of most copies of the movie to date,
being the top influencer, triggering the sale of most sale of a movie with a single article.

### Point (C)

The distribution of the future payments to the micro share holders can happen in a number of ways, depending on the needs of the project and the platform. One way would be to implement the payment distribution to be entirely within the platform. So when the revenue distribution happens, the revenue share of each micro share would be sent to the account of the user holding that micro share at that time. The revenue distribution can also be implemented entirely on the blockchain, so that depending on which blockchain is used for the payment distribution, the revenue share of each of the digital asset can be distributed to the appropriate addresses holding those digital assets or directly to the users holding those assets, whichever functionality is better supported by that specific implementation of the blockchain. The payment distribution on the blockchain can be initiated by running the appropriate commands supported by the blockchain and any of the associated protocols or by any other supported means. A combination of on platform and on blockchain distribution might also be possible for cases where some of the micro shares are exported as digital assets on to the blockchain while some of the microshares held on the platform.

### Point (F)

This section defines the incentivization model associated with the project. Incentivization model refers to the payment or equity distribution model based on which the microshares of a given product or content or service are distributed to consumers. Depending on the needs of a project, the incentivization model may be setup to be as simple or as complex as needed. In this example the project follows a simple linear decay incentivization model that is setup to incentivize the first 500,000 purchasers of the movie. Other valid examples include an incentivization model in which a percentage of the incoming revenue is equally distributed amongst all microshare holders at regular intervals. Even though this example is for the incentivization of the purchasers of the movie, it could be applied to incentivize any desired action of the user such as renting, promoting, watching and more broadly signing up or subscribing to a desired service or platform.

Let us step through a similar incentivization model as an example, the incentivization model may be setup so that the first 1,000,000 consumers who choose to purchase or rent a movie, initiate any other desired action, or satisfy a desired condition, may be awarded a micro share in the future lifetime profits of the movie. Each of those transactions, let's say either purchasing or renting of the movie would be entitled a microshare ranging between 0.0003% to 0.000075% of the future profits depending on when the copy was purchased. The very first copy of the movie may get a 0.0003% share in future profit while the millionth copy may get a share of 0.000075% in future profits.

In this above example, the number of transactions which would receive microshares is setup to be a fixed number, but in alternate embodiments of the platform, this could be an ever increasing number depending on the needs of the project.

In the above example the percentage of profit sharing per micro share decreases linearly with each successive purchase. This need not always be the case. Other embodiments of the platform might incorporate incentivization models with numerous other variations, such as varying the percentage of profit sharing per microshare based on the time of the purchase or various other criteria. Even though the above example uses a linearly decaying model to determine the percentage of future profits awarded to each micro share. Other models of reward structuring such as exponential fall off model or a stepped function model or a constant model could be implemented. Instead of a falloff over time, the reward structure could be made to ramp up with time or vary based on various events or combine these and other models are also possible.

In alternate embodiments, the reward structure of the incentivization model could be varied based a number of other criteria, such as the marketing contributions of a consumer to the project, an example may be a consumer whose efforts has resulted in 10,000 retweets might be awarded additional microshares or alternatively his percentage of profit sharing per micro share may also be increased.

In other alternate embodiments, different classes of microshares might be issued based on the various criteria and categories. For example, a class of microshares might be issued for early buyers who take part in the pre-sale of a product or content or service, then another class of microshares with differing profit sharing/reward structure and rights might be issued to consumers who are identified as influencers, and the consumers who buy the product or content or service after it is fully finished might be awarded a different class of micro shares that has different reward structure and rights associated with it, than the early pre-sale buyers. A project could issue any number of these differing classes of microshares based on its needs and overall strategy.

In other alternate embodiments, certain conditions could trigger awarding of: (1) multiple microshares, (2) or result in the increased of profit sharing percentage per microshare, (3) or awarding of special commemorative microshares tied with gamification elements such as badges and tags. For example, a scenario where a consumer is able to bring 10,000 new buyers to the product or content or service in 2 just days, may be issued a unique commemorative microshare tied to this accomplishment, which may also include an increased profit sharing percentage.

As anyone skilled in the art would understand, the scope of how an incentivization model may be structured, is in no way limited to the above examples and scenarios. Any variations of the above mentioned scenarios along with numerous other scenarios and models that are too numerous to list individually might be combined together to create an incentivization model.

The incentivization models may either be implemented in a completely automated manner using programming logic or parts of the model may require manual intervention and oversight depending on the needs of the project. Multiple incentivization models may be combined together to in various combinations in order to produce the desired profit sharing distribution model for a given project.

### Point (G)

In some alternate embodiments, a project may also be setup to incorporate any and all intellectual property rights associated with the project and also partial/full ownership/revenue rights to any future derivative work based on the intellectual property associated with this project as the case may be.

This step may require a manual or an automated audit process to be implemented to oversee that the intellectual property rights and all the revenue sources associated with them are properly reflected in the overall project revenue.

As another example, an alternate embodiment of a social contract might be implemented for a project such as a TV series that might include a provision to create future seasons of the TV show contingent upon the revenue generated by the current season.

In an example scenario, a TV series might have the first season consisting of 8 episodes already made. This TV series might get listed on the platform with a social contract similar to the above described independent film, but with an additional clause stating that if the first season sold more than 2 Million copies, then the creators of the project might initiate a vote in which all the holders of the microshares of the project, or a certain number of majority microshare holders might vote on creating a second season of the series based on the proceeds received from the sale of the first season. In different embodiments of the platform, the voting may be implemented fully within the platform itself, or can be implemented on the blockchain through one of the supported voting mechanisms, or it may be a combination of both on platform and on blockchain voting as the case may need to be.

In another embodiment of the platform, an early stage product idea might get listed on the platform with only a few sketches and a pitch video. In such a case, the project creators project might choose to issue different classes of microshares. A pre-sale class of microshare, where purchases made by consumers interested in seeing the idea turned into a fully finished product might generate a pre-sale class microshare. A second class of ‘consumer’ class microshares might be generated for purchases made by consumers who buy the product after it has been manufactured. The pre-sale class of microshares may have additional rights and benefits compared to the ‘consumer’ class microshares. Such a project might have a social contract similar to the following,

1) All forms of revenue generated by the product throughout its entire lifetime will flow into this address, 15HCzh8AoKRnTWMtmgAsT9TKUPrQ6oh9BQ

2) Each purchase of the product in the presale stage will generate a microshare, which has the rights to a small share in the future lifetime profits that this product generates, once the initial costs are recouped by the creators, the micro shares will be generated as digital assets.

3) A total of 10,000 presale micro shares will be available, with each pre-sale purchase being awarded a 0.004% in the future profits generated from the sale of the product after the costs are recouped.

4) A total of 100,000 consumer class micro shares will be available for the first 100,000 purchasers of the product after it has been manufactured, with each purchase being awarded a 0.0004% in the future profits at this stage.

5) The product will be priced at $50.00

6) The purchasers who buy the product will have the option to not receive the product but instead just receive only the microshare. In this case, the digital asset representing the microshare will be tagged as an ‘Early Buyer’ digital asset.

### Point (1)

The address 15HCzh8AoKRnTWMtmgAsT9TKUPrQ6oh9BQ will receive all the revenue generated from the sale of the product both online and offline. The offline purchasers of the product who might buy the product from in store might be able to redeem their microshare by scanning a QR code on the product or by using other similar means, including redeeming it using a unique code printed on the product.

### Point (6)

Sometimes purchasers might buy the product to primarily take part in the future profit sharing, rather than for using the product. This project provides a special tag to make those transactions stand out by tagging those digital assets as ‘Early Investors’. A number of those tags can be assigned to digital assets to add elements of gamification for the purchasers.

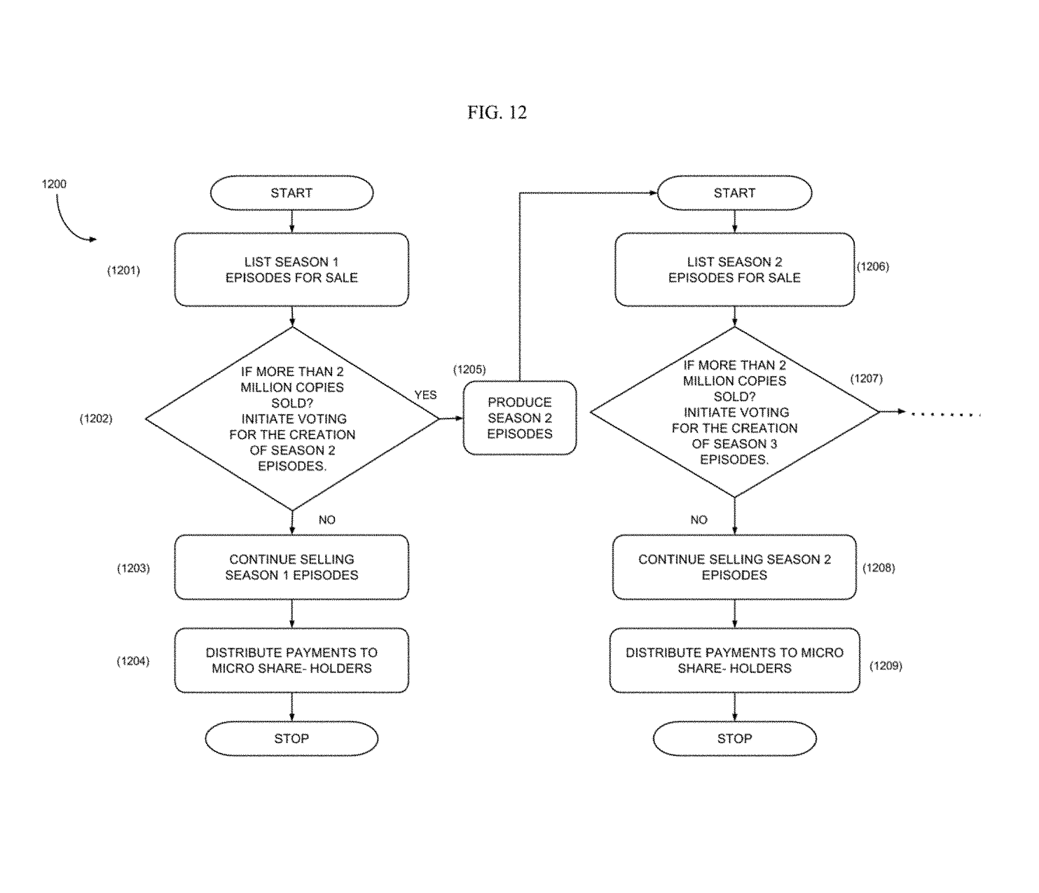

FIG. 12 illustrates a block diagram depicting an exemplary implementation of a social contract for a television series project on the incentivization platform, which may be used in an exemplary embodiment of the present invention;

In this embodiment, the television series might get listed on the platform with only the first season of made available for purchase or renting 1201. If the first season sells more than 2 million copies of the television series then the project creators might initiate voting amongst all the microshare holders in the project, to see if there is majority interest in using some of the revenue generated in the first season to create Season 2 of the TV series 1202. If the voting is successful then the second season of the TV series is produced and listed on sale or rent on the platform 1205, 1206. The second season might get listed on the platform as part of the same project as the first season or as a separate project, depending on how the social contract and incentivization model is setup for the first season's project. If the vote is unsuccessful, then the first season's project continues to sell more copies and distribute future profits as per the social contract and incentivization model 1203, 1204. More and more seasons of this television series may be produced by future voting as the series continues to do well 1207.

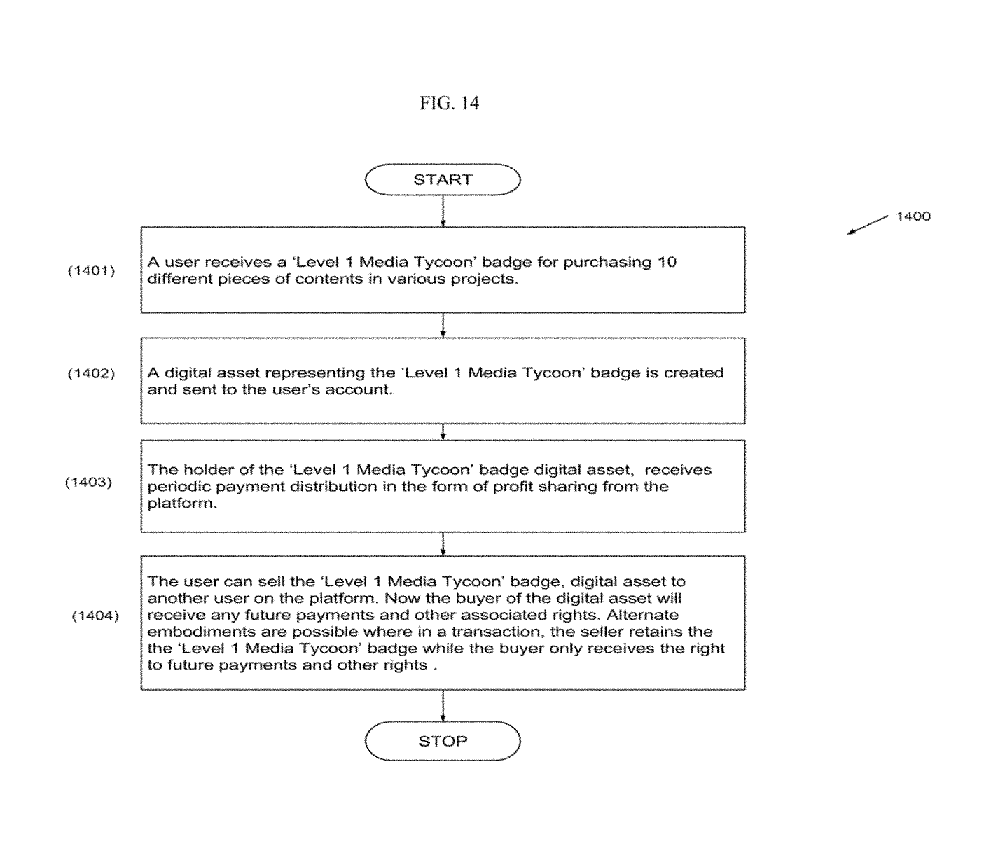

FIG. 14 illustrates a block diagram depicting an exemplary implementation of gamification elements on the incentivization platform, which may be used by an exemplary embodiment of the present invention. In a first step, 1401, a user receives a ‘Level 1 Media Tycoon’ badge for purchasing a number of different pieces of content (for example, 10) in various projects. In a next step 1402, a digital asset representing the ‘Level 1 Media Tycoon’ badge may be created and sent to the user's account. In a next step 1403, the holder of the ‘Level 1 Media Tycoon’ badge digital asset, may receive periodic payment distribution in the form of profit sharing from the platform. In a final step 1404, the user can sell the ‘Level 1 Media Tycoon’ badge digital asset to another user on the platform. Now the buyer of the digital asset may receive any future payments and other associated rights. Alternate embodiments are possible where in a transaction, the seller retains the ‘Level 1 Media Tycoon’ badge while the buyer only receives the right to future payments and other rights.

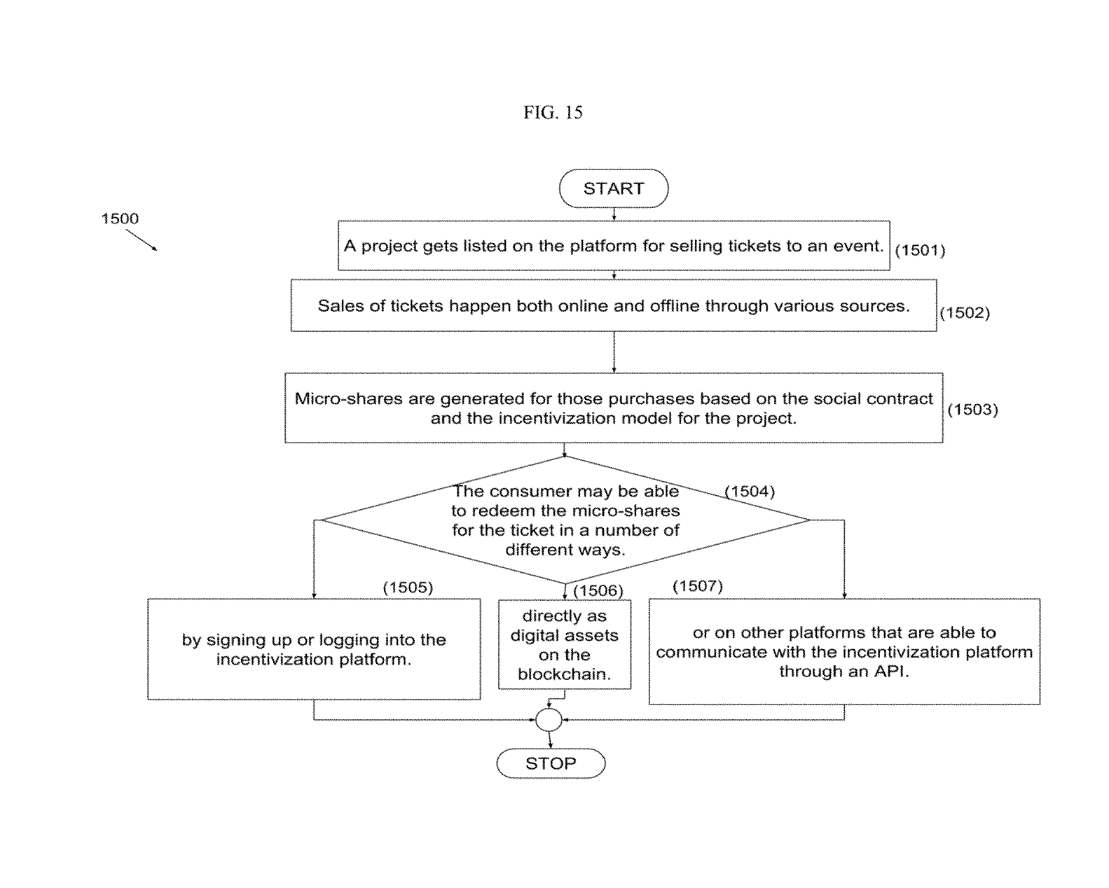

FIG. 15 is an illustration depicting an exemplary implementation of a project for selling event tickets on the platform, which may part of an exemplary embodiment of the present invention;

In some embodiment of the platform, a project for incentivizing sales of event tickets might get listed on the platform 1501. The project may be implemented such that a part of the overall profits generated from the event might get distributed to the microshare holders as per a social contract and an incentivization model. The early buyers of the tickets might be awarded microshares based on the social contract and an incentivization model 1503. Consumers who purchase the tickets directly on the incentivization platform might be awarded the microshare directly on the incentivization platform itself (as detailed in FIG. 6, FIG. 7, FIG. 8). For consumers who purchase the ticket on another platform, in some embodiments, they might be able to redeem their microshares by signing up and logging on to the incentivization platform, and in certain embodiments by entering their purchase details on their incentivization platform 1505. In some other embodiments, the incentivization platform might provide APIs that other platforms can implement such that when a consumer purchases a ticket on the other platform, the incentivization platform may generate, a microshare in the form of a digital asset that may be directly issued on a blockchain and awarded to the consumer on the blockchain 1506, or in some other embodiments, the microshare may be generated by the incentivization platform and sent directly to the other platform in which he or she made the purchase 1507. In case the purchase happens at an offline ticket counter, then the consumer may be able to redeem the microshare by scanning a QR code or entering a special code from the ticket, the micro shares may be redeemed by logging on to the incentivization platform or by receiving directly on the blockchain or through other platforms that interact with the incentivization platform through an API. Some embodiments might implement a combination of all these approaches 1505, 1506, 1507.

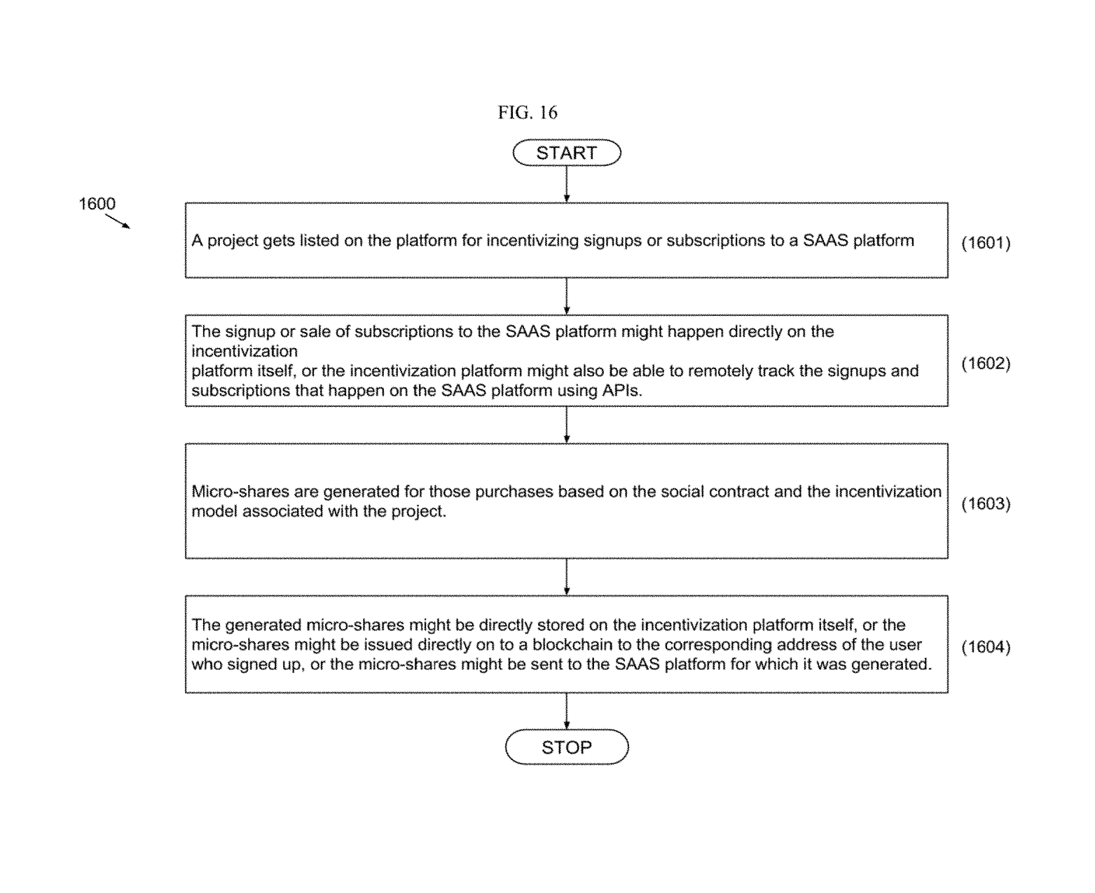

FIG. 16 is an illustration depicting an exemplary implementation of a project for incentivizing subscription or signups to a SaaS platform, which may be part of an exemplary embodiment of the present invention;

In some embodiments of the platform, a project for incentivizing the signups or subscriptions on a SAAS platform might be listed on the incentivization platform 1601. The transactions generating new signup and subscriptions might happen directly on the incentivization platform or it might happen remotely on the SAAS platform, and might be tracked by the incentivization platform through API calls 1602. The social contract and the incentivization model may be setup to share a portion of the eventual profit or revenue or part of the equity of the SAAS platform or other rights with the early users who subscribe or signup to the platform 1603. Users who sign up or subscribe for the SAAS platform directly through the incentivization platform might be awarded the micro share directly on the incentivization platform itself (as detailed in FIG. 6, FIG. 7, FIG. 8). In some embodiments, the consumers who sign up or subscribe directly on SAAS platform might be able to redeem their microshares by signing up and logging on to the incentivization platform, and in certain embodiments, by entering their purchase details on the incentivization platform. In some other embodiments, the incentivization platform might provide APIs that the SAAS platform can implement, such that when a user signs up or subscribes to the SAAS platform, the incentivization platform may generate, a microshare in the form of a digital asset that may be directly issued on a blockchain and awarded to the consumer on the blockchain, or in some other embodiments, the microshare may be generated by the incentivization platform and sent directly to the SAAS platform 1604.

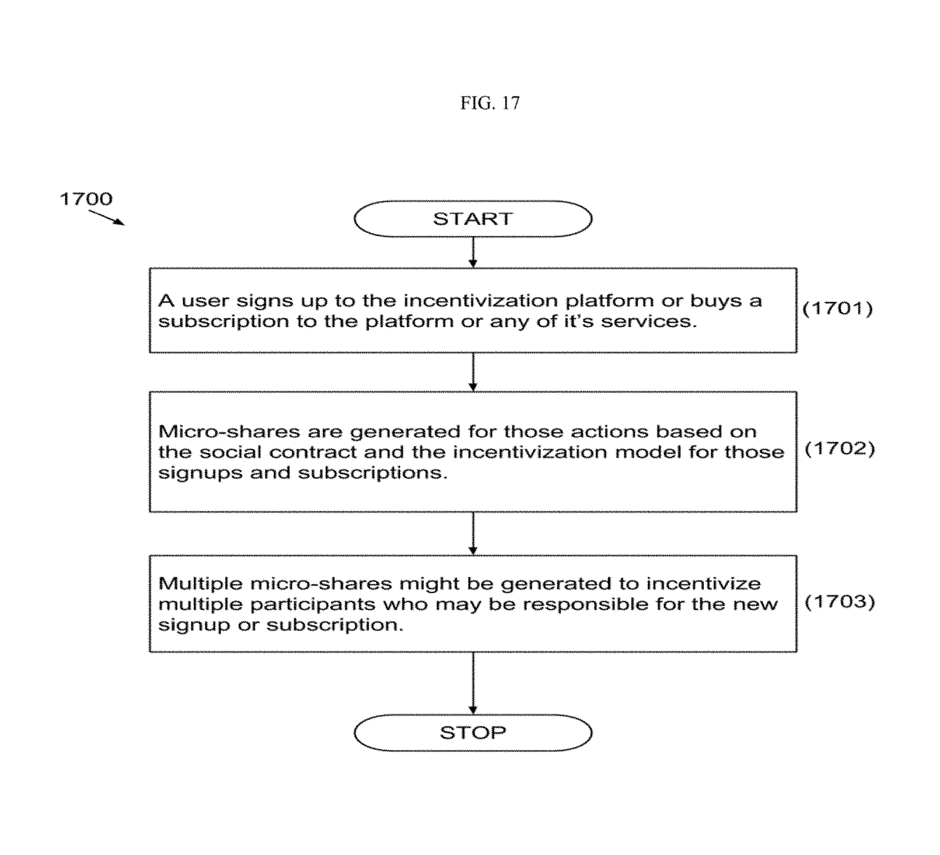

FIG. 17 is an illustration depicting an exemplary implementation of a methodology for incentivizing user signup and subscriptions on the platform, which may be part of an exemplary embodiment of the present invention;

In a valid embodiment of the incentivization platform, when a user signs up to the incentivization platform or subscribes to any of its services 1701, those transactions might generate microshares 1702. Those microshares might provide rights to a share in the eventual profit or revenue or part of the equity of the incentivization platform, including any other additional rights, depending on the social contract and incentivization model associated with them. In some embodiments, more than one microshare might be generated for a single transaction if multiple participants need to be incentivized for their contributions that resulted in the occurrence of that transaction 1703. In this embodiment the transaction refers to the user sign up or subscriptions, in other valid embodiments, any other user actions including, but not limited to purchasing, renting, promoting or marketing might be the transactions that generates microshares.

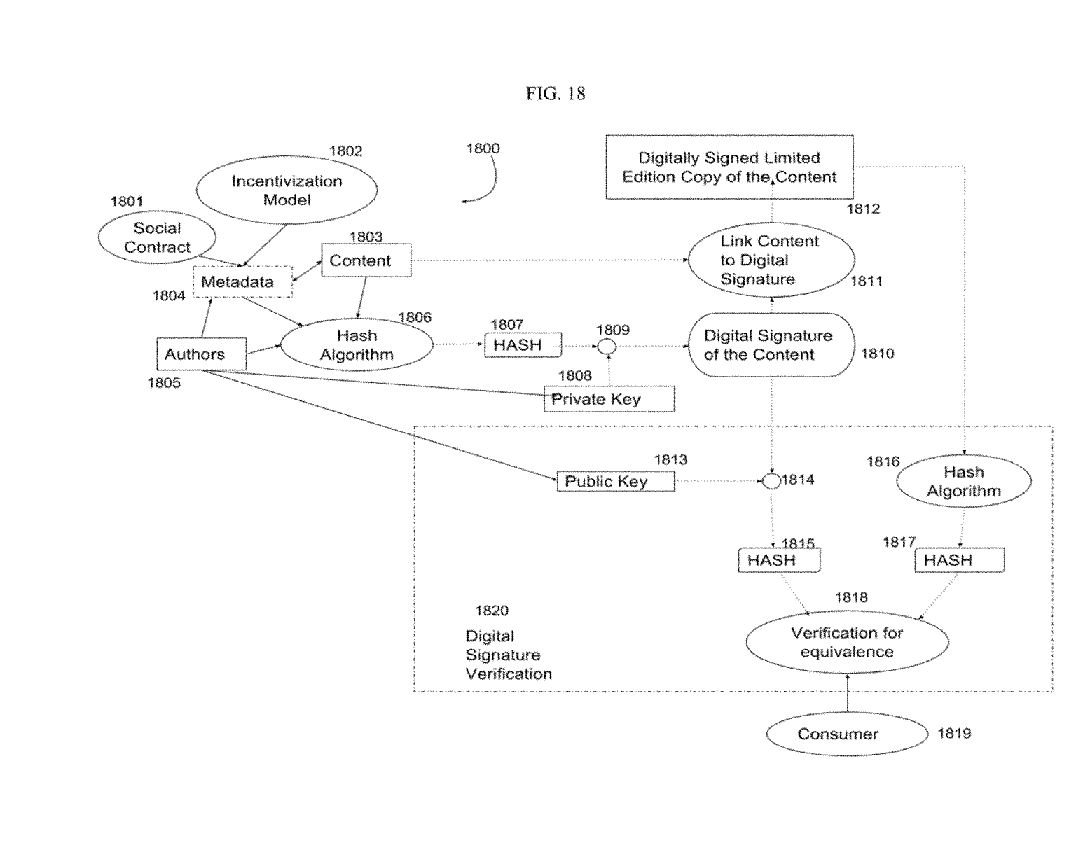

FIG. 18. illustrates a block diagram depicting an exemplary implementation of a digital signature infrastructure, which may be used by an exemplary embodiment of the present invention.

The digital signature infrastructure may consist of one or more hashing algorithms such as cryptography based SHA1, SHA256, MD5 or other possible hashing algorithms that may or may not rely on cryptography 1806. When the author (or) authors 1805 issue a piece of content that needs to be digitally signed, the platform will hash together one or more of the following components and create a unique identifier, which we will refer to as a hash, that is unique for that specific copy of content,
i) The content container 1803 that holds all the data - this could be a movie file for a video or a image file in case of images or any other file format based on the type of content. Also the content may or may not have,
a) some metadata about its corresponding microshare (defined by the Social contract 1801 and the incentivization model 1802 associated with the issuing project).
b) the names and details of the issuing authors and other related information, directly embedded in the content file which is present in the content container, or optionally a link could be embedded in the content file to point to a location where this information is available.
   ii) The metadata 1804 that defines the microshare associated with this copy of the content file may also be given as a separate input into the hashing algorithm 1806, this may include any information related to the social contract 1801 and the incentivization model 1802 associated with the microshare and other related information, or optionally it could also be a link a location where this information is available.
   iii) The names and other relevant information associated with the issuing authors 1805 may also be feed as a separate input into the hash. Here (and in the rest of this document) the term ‘authors’ refers to either the content creator and or other individual and organization on whose behalf the digitally signed copy of the content is being issued.
   This hash may then be encrypted (also may be referred to as being digitally signed) 1809 using the private key of one or more of the issuing authors 1808 to create a unique digital signature 1810 for that particular copy of the digital content. Valid embodiments of this digital signature infrastructure may use technologies other than asymmetric key cryptography, such as symmetric key cryptography or other newer technologies to create the digital signature. The digital signature may also be referred to using other terms such as MAC (Message Authentication code), HMAC (Hashed Message Authentication Code), CMAC (Cipher based Message Authentication Code). This digital signature can then be linked to the content file 1811, 1812 by any number of means including, but not limited to, using a QR code or by directly providing a link to the digital signature along with the content file or embedding the URL into the metadata of the file.

The platform may also provide a means for consumers to verify the authenticity of the digitally signed copies of the content 1820 by enabling them to use the public key 1813 of the issuing authors to decrypt 1814 the digital signature associated with a particular copy of the digitally signed content, this decrypted signature results in a hash 1815, This hash 1815 can then be compared against the hash 1817 generated by running the digitally signed copy of the content file 1812 directly through the hashing function 1816 that was earlier used during the signing/encryption process 1806. If the two hashes match 1818, then the platform can inform the consumer 1819 that the digitally signed copy that he or she is trying to verify is indeed authentic and digitally signed by the original author. Alternatively, the platform may provide only some of the pieces of information needed for this verification, such as the public key of the authors 1813 and/or the hashing algorithm 1806 used during signing. The user may need to do the verification offline without using the platform.

This example illustrates just one method for a digital signature infrastructure using an asymmetric key setup for encryption. An equivalent digital signature infrastructure might use a symmetric key setup instead of an asymmetric key setup for encryption or a combination of the two. Also the encryption might be handled by a different algorithm that does not rely on cryptography at all. In the case of a symmetric key encryption setup, the public and private keys of the authors would be replaced by a single encryption key. There are a number of other means and methods to accomplish the digital signing of the copies of the limited edition content files that may be utilized as needed.

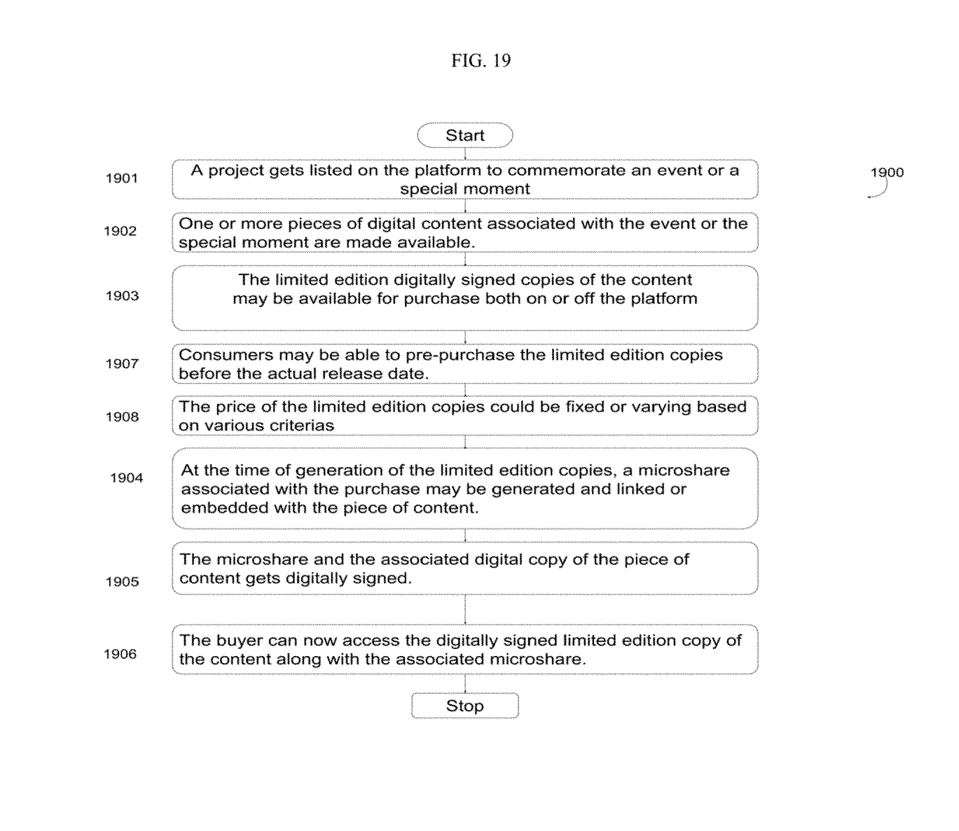

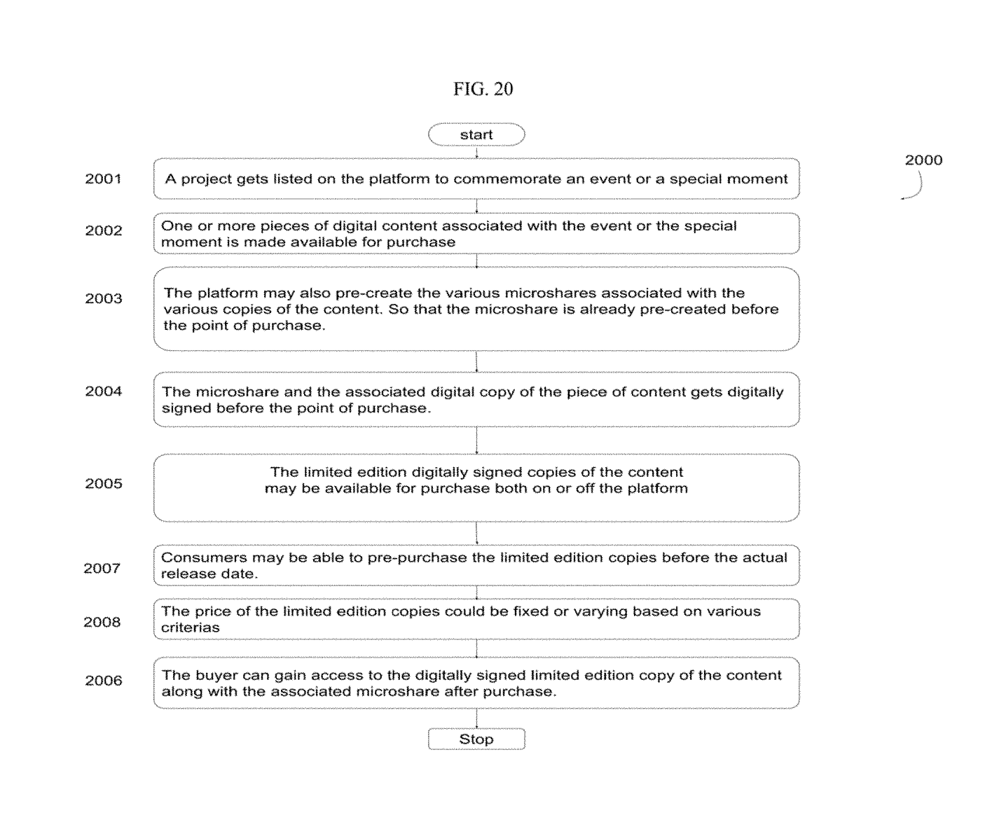

FIG. 19, FIG. 20 Illustrate exemplary implementations of this invention combined with a digital signature infrastructure (as depicted in FIG. 18) to issue limited edition copies of the content that are digitally signed by the authors. Each purchase of this limited edition copy of the content might trigger the creation of a micro share 1904 associated with it (based on the incentivization model 1802 and the social contract 1801 associated with the project). This microshare may be either directly embedded as part of the content or the microshare can be issued separately and a link may be established between the content and the micro share.

A project could be created to commemorate an event or a special moment. The events or special moments could include competitions or an award ceremonies happening either online, directly on the platform or elsewhere or offline 1901. One or more pieces of digital content could be created and be made available on the platform to commemorate that event or a special moment 1902. Consumers can buy digitally signed limited edition copies of this content along with its associated micro share 1903. The consumers may be able to pre purchase the limited edition copies before the actual release date 1907. The pricing mechanism for the limited edition copies could either be a fixed flat pricing or a varying pricing model, where the pricing is varied between different copies based on factors including but not limited to the number of previous copies sold or the time at which a copy was sold or other heuristics based on the popularity of the issuing author, such as their popularity in social media or other ranking mechanisms 1908. The issuance of limited edition copies may be limited based on a number of factors (collectively referred to edition limit), to either a fixed number of maximum copies or restricted within a specific time window or both. The edition number associated with any specific copy may be represented by an edition value and/or an edition identifier. The limited edition copies of the content can be signed by one or more individuals or organizations (referred to as Authors) associated with that event/special moment (as covered in FIG. 18) 1905. This microshare may be either directly embedded as part of the content or the microshare can be issued separately and a link may be established between the content and the microshare.

Many variations on this models can be implemented such that each digitally signed limited edition copy comes with a preassigned microshares rather than being created by a trigger action, such as a consumer purchase, or during the process of the limited edition copy generation. But the end result being the same that, each limited edition digitally signed copy has an associated microshare, 2003, 2004 (referring to FIG. 20)

The microshares associated with these limited edition copies can have any number of incentivization models associated with them, including but not limited to scenarios in which the amount of microshare associated with each copy reduces over time, or the microshare might reduce with each additional purchase or any number of other possible scenarios as described in detail previously.

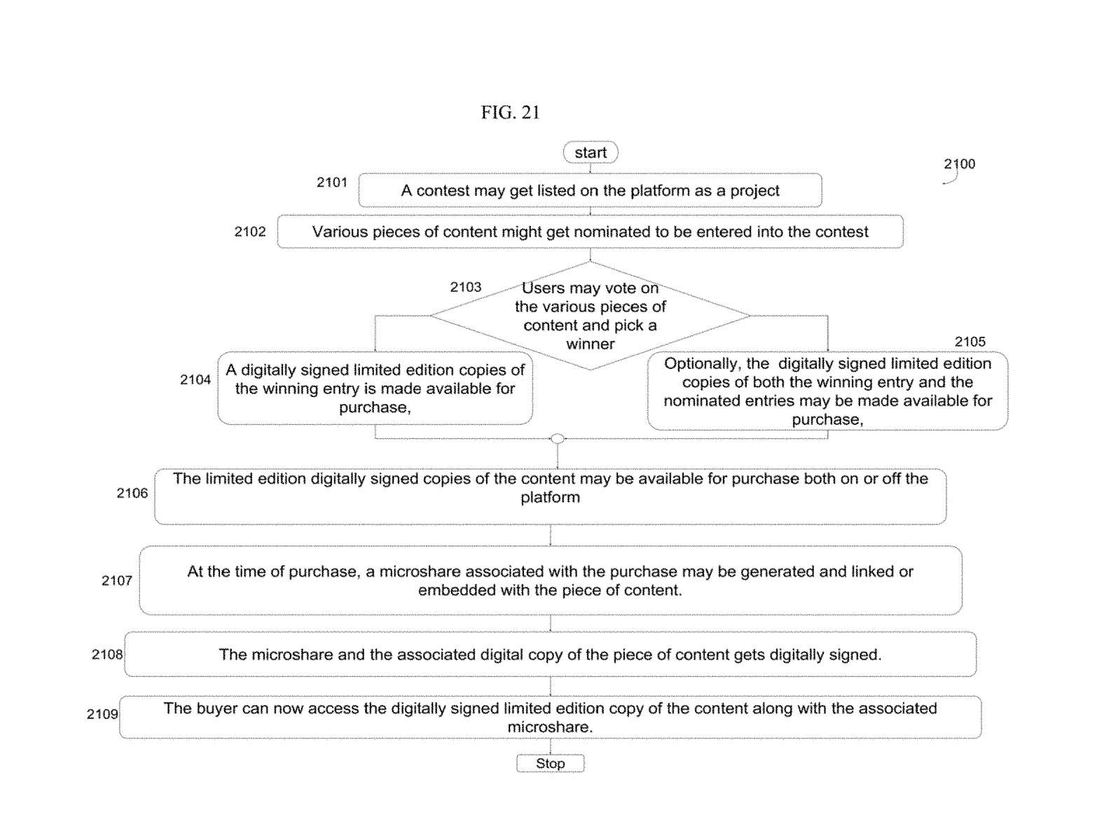

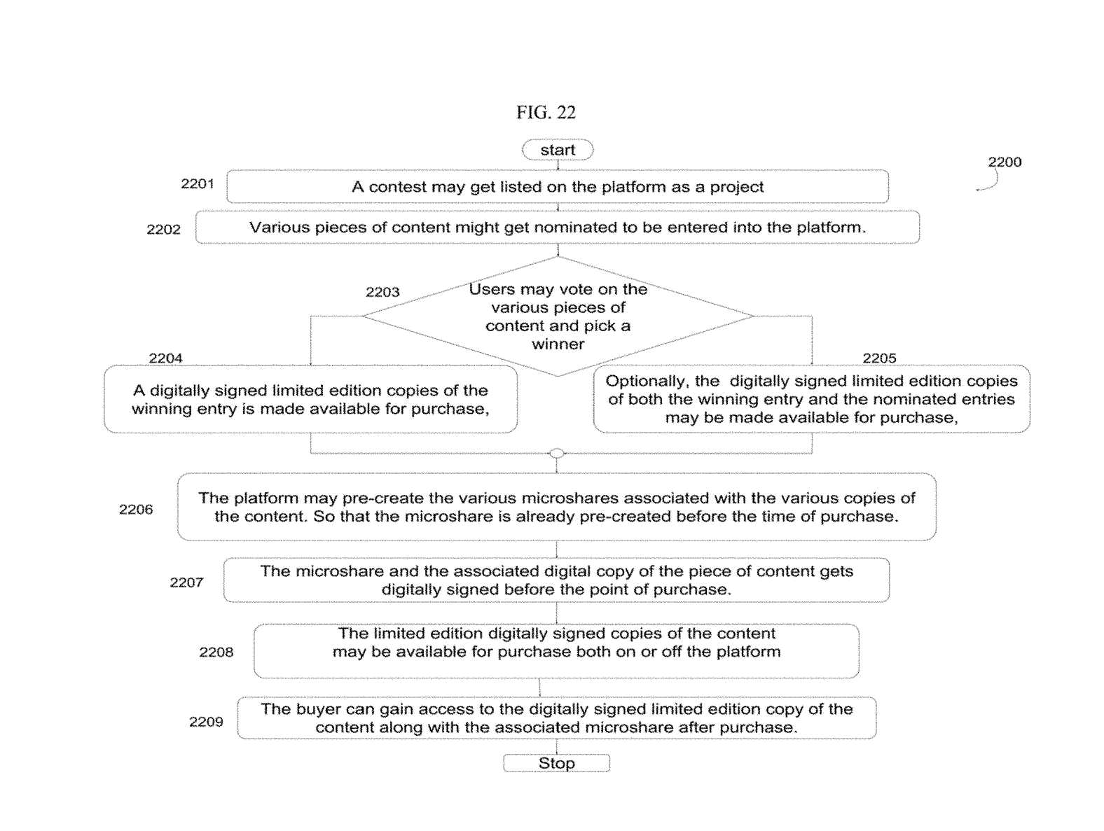

FIG. 21, FIG. 22 Illustrate exemplary implementations of this invention combined with a digital signature infrastructure (as depicted in FIG. 18) to issue limited edition copies of the content that are digitally signed by the Authors. Each purchase of this limited edition copy of the content might trigger the creation of a microshare 2107 associated with it (based on the incentivization model 1802 and the social contract 1801 associated with the project). This microshare may be either directly embedded as part of the content or the microshare can be issued separately and a link may be established between the content and the microshare.

A contest 2101 may be established in which various pieces of content such as videos, images or other digital content gets entered into the contest and gets voted on by users. This contest can be hosted directly on the incentivization platform or at a different location, including on the blockchain. The users may be able to participate in the contest by voting directly on the platform or the voting might take place in some other location, including on a blockchain 2103.

Digitally signed limited edition copies of content can also be issued by winners of the contest 2104, 2105, 2106. When a consumer purchases one of these limited edition copies, this may trigger the creation of a microshare tied to that purchase, (based on the incentivization model 1802 and the social contract 1801 associated with it) 2017. This microshare may be either directly embedded as part of the content or the microshare can be issued separately and a link may be established between the content and the microshare. One or more pieces of content may get nominated to the contest and get voted on by the community. At the end of the contest either just the winners 2014 or both the winners and all the entrants 2015 may issue digitally signed limited edition versions of their respective pieces of content for purchase.

Many variations on this models can be implemented such that each digitally signed limited edition copies comes with a preassigned micro shares rather than being created by a trigger action, such as a consumer purchase, at the moment of purchase. But the end result being the same that, each limited edition digitally signed copy has an associated microshare 2206, 2207 from FIG. 22.

The microshares associated with these limited edition copies can have any number of incentivization models associated with them, including but not limited to scenarios in which the amount of microshare associated with each copy reduces over time, or the microshare might reduce with each additional purchase or any number of other possible scenarios as described in detail previously.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6). In some embodiments, the methods and/or system components which may be located and/or performed remotely include, without limitation: parts of the platform may make use of a blockchain. Depending on the nature of blockchain being used, some or all of the participating nodes in the blockchain may be located outside of the jurisdiction of USA.

It is noted that according to USA law, all claims, in this application or of any further Application derived therefrom, must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breathe life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims, in this application or of any further Application derived therefrom, must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTOs Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the claims, in this application or of any further Application derived therefrom, that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the claims , in this application or of any further Application derived therefrom, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing data exchange according to the present invention will be apparent to those skilled in the art. Various aspects of the invention have been described above by way of illustration, and the specific embodiments disclosed are not intended to limit the invention to the particular forms disclosed. The particular implementation of the data exchange may vary depending upon the particular context or application. By way of example, and not limitation, the data exchange described in the foregoing were principally directed to movable object implementations; however, similar techniques may instead be applied to non-movable objects such as floors and walls, which implementations of the present invention are contemplated as within the scope of the present invention. The invention is thus to cover all modifications, equivalents, and alternatives falling within the spirit and scope of the claims, in this application or of any further Application derived therefrom. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims, in this application or of any further Application derived therefrom.

The corresponding structures, materials, acts, and equivalents of all means or step plus function elements in the claims, in this application or of any further Application derived therefrom, are intended to include any structure, material, or act for performing the function in combination with other claimed elements as specifically claimed.

The Abstract is provided to comply with 37 CFR Section 1.72(b) requiring an abstract that will allow the reader to ascertain the nature and gist of the technical disclosure. It is submitted with the understanding that it will not be used to limit or interpret the scope or meaning of the claims. The claims, in this application or of any further Application derived therefrom, are hereby incorporated into the detailed description, with each claim standing on its own as a separate embodiment.

What is claimed is:

1. A system for assigning digital property rights to digital media comprising:
a network-connected electronic digital signature server comprising at least a memory and a processor and further comprising programmable instructions stored in the memory and operating on the processor, the instructions configured to assign digital property rights to digital media, comprising:
a content container;
an author identifier;
an owner identifier;
an edition identifier;
a social contract;
an incentivization model;
a hashing algorithm;
wherein the content container comprises digital media;
wherein the author identifier corresponds to one or more authors associated to the digital media;
wherein the owner identifier corresponds to one or more owners associated to the digital media;
wherein the edition identifier corresponds to the edition associated to the digital media;
wherein the social contract comprises at least one microshare associated to the digital media;
wherein the incentivization model defines at least future revenue rights, associated to the digital media, for the one or more owners;
wherein the hashing algorithm executes a hash function on a project selected from the group consisting of, the content container, the author identifier, the owner identifier, the edition identifier, the social contract, and the incentivization model to create a unique hash identifier.

2. The system of claim 1, further comprising:
an encryption algorithm;
wherein the encryption algorithm encrypts the unique hash identifier using a private key of the one or more authors to create a unique digital signature for the digital media.

3. The system of claim 1 or claim 2, wherein the project selected from the group consisting of, the content container, the author identifier, the owner identifier, the edition identifier, the social contract, and the incentivization model, is pre-combined into a single input before the hash function is executed, and the hash function executes using the single input.

4. The system of claim 2, further comprising:
an edition value;
wherein upon the creation of the digital signature, the edition value is incremented and the edition identifier is created associated to the digital signature.

5. The system of claim 4, further comprising:
an edition limit;
wherein prior to an execution of the hash function, the edition value is compared to the edition limit;
wherein upon the edition value being greater than or equal to the edition limit, preventing the hash function from executing.

6. The system of claim 1, comprising:
a media property rights blockchain;
a plurality of connections via the network from a plurality of other computers;
wherein one or more blocks are generated comprising, at least, the at least one micro shares;
wherein the one or more blocks are transmitted to at least one or more other computers of the plurality of computers;
wherein the one or more other computers of the plurality of computers are configured to determine acceptance of the one or more blocks and to append the one or more blocks to the media property rights blockchain.

7. The system of claim 6, wherein the at least one or more computers of the plurality of computers validate the one or more transmitted blocks.

8. The system of claim 7, wherein upon a positive authentication of the one or more transmitted blocks by the one or more computers of the plurality of computers, the one or more transmitted blocks are permanently recorded on the media property rights blockchain.

9. The system of claim 2, wherein the digital signature is linked to the digital media.

10. A method for assigning digital property rights to digital media comprising:
deploying a network-connected electronic digital signature server comprising at least a memory and a processor and further comprising programmable instructions stored in the memory and operating on the processor, the instructions configured to assign digital property rights to digital media, comprising the steps of:
receiving, at a content container, digital media;
receiving, at an author field, one or more names of authors associated to the digital media;
receiving, at an owner field, one or more names of owners associated to the digital media;
associating, at a social contract, one or more microshares to the digital media;
defining, at an incentivization model, at least future revenue rights associated to the digital media for the one or more owners;
performing, at a hashing algorithm, a hash function on components selected from the group consisting of, the content container, the author field, the owner field, the social contract, and the incentivization model.

11. The method of claim 10, further comprising the steps of:
encrypting, by an encryption algorithm, the project using a private key of the one or more authors to create a unique digital signature for the digital media.

12. The method of claim 10 or claim 11, further comprising the steps of:
pre-combining the project selected from the group consisting of, the content container, the author identifier, the owner identifier, the edition identifier, the social contract, and the incentivization model into a single input prior to the execution of the hash function; and
executing the hash function using the single input.

13. The method of claim 11, further comprising the steps of:
upon creating the digital signature, incrementing an edition value;
creating the edition identifier associated to the digital signature.

14. The method of claim 13, further comprising the steps of:
comparing, prior to an execution of the hash function, the edition value and an edition limit;
upon the edition value being greater than or equal to the edition limit, preventing the hash function from executing.

15. The method of claim 10, further comprising the steps of:
generating one or more blocks are comprising, at least, the at least one microshares;
transmitting the one or more blocks to at least one or more other computers of a plurality of computers connected via the network;
wherein the one or more other computers of the plurality of computers are configured to determine acceptance of the one or more blocks and to append the one or more blocks to the media property rights blockchain.

16. The method of claim 15, further comprising the step of validating the one or more transmitted blocks by the at least one or more computers of the plurality of computers.

17. The method of claim 16, further comprising the step of upon a positive authentication of the one or more transmitted blocks by the one or more computers of the plurality of computers, permanently recording the one or more transmitted blocks are on the media property rights blockchain.

18. The method of claim 11, further comprising the step of:
linking the digital signature to the digital media.
